(19) United States
(12) Patent Application Publication
(10) Pub. No.: US 2026/0078291 A1
(43) Pub. Date: Mar. 19, 2026

(54) WORKING MEDIUM, COMPOSITION FOR THERMAL CYCLE SYSTEM, THERMAL CYCLE DEVICE, AND THERMAL CYCLE METHOD

(71) Applicant: AGC INC., Tokyo (JP)

(72) Inventor: Hiroki HAYAMIZU, Tokyo (JP)

(73) Assignee: AGC INC., Tokyo (JP)

(21) Appl. No.: 19/394,552

(22) Filed: Nov. 19, 2025

Related U.S. Application Data
(63) Continuation of application No. PCT/JP2024/018698, filed on May 21, 2024.

(30) Foreign Application Priority Data
Jun. 1, 2023 (JP) 2023-091156

(51) Int. Cl. C09K 5/04

(52) U.S. Cl. CPC C09K 5/044; C09K 2205/126; C09K 2205/128; C09K 2205/22

(57) ABSTRACT

There are provided a working medium containing HFO-1234yf, HCFO-1224yd(Z), and HFC-134a, in which a content of HFC-134a is 15.0% by mass or less relative to the total content of HFO-1234yf, HCFO-1224yd(Z), and HIFC-134a, a content of HCFO-1224yd(Z) is 12.0% by mass or less relative to the total content of HFO-1234yf, HCFO-1224yd(Z), and HFC-134a; and a content of HFO-1234yf is 73.0% by mass or more relative to the total content of HFO-1234yf, HCFO-1224yd(Z), and HFC-134a, and applications thereof.

### CROSS-REFERENCE TO RELATED APPLICATION

This application is a Continuation of International Application No. PCT/JP2024/018698, filed May 21, 2024, which claims priority to Japanese Patent Application No. 2023-091156 filed Jun. 1, 2023. Each of the above applications is hereby expressly incorporated by reference, in its entirety, into the present application.

### TECHNICAL FIELD

The present disclosure relates to a working medium, a composition for a thermal cycle system, a thermal cycle device, and a thermal cycle method.

### BACKGROUND ART

Conventionally, working mediums such as working mediums for heat cycles, for example, refrigerants for freezing machines, refrigerants for air-conditioning equipment, working mediums for electric power generation (for example, waste heat recovery power generation), working mediums for latent heat transport apparatuses (for example, heat pipes), and secondary coolant mediums have been fingered as affecting the stratospheric ozone layer and affecting global warming. Therefore, it is urgently necessary to develop a working medium that less affects the ozone layer and that is small in global warming potential.

In particular, 1,1,1,2-tetrafluoroethane (R-134a) is non-flammable and is low in boiling point, and therefore is used in air-conditioning equipment for automobiles, freezing equipment, or the like, but has a high global warming potential (GWP (AR5)) of 1300, and therefore alternatives thereto are studied.

Patent Literature 1 describes a working medium for thermal cycles containing 1-chloro-2,3,3,3-tetrafluoropropene and 2,3,3,3-tetrafluoropropene, in which the total content of 1-chloro-2,3,3,3-tetrafluoropropene and 2,3,3,3-tetrafluoropropene contained in the working medium for thermal cycles is 50% by mass or more, and the ratio represented by 1-chloro-2,3,3,3-tetrafluoropropene: 2,3,3,3-tetrafluoropropene is in a range of from 30:70 to 99:1 on a mass basis.

### CITATION LIST

### Patent Literature

Patent Literature 1: International Patent Publication 2019/022138

### SUMMARY OF INVENTION

### Technical Problem

However, in the working medium described in Patent Literature 1, since the content of 1-chloro-2,3,3,3-tetrafluoropropene is 30% by mass or more, the azeotropicity is poor, and there is a tendency for the temperature glide to become high. In addition, since the content of the 2,3,3,3-tetrafluoropropene is 70% by mass or less, the volumetric capacity is lowered, and the performance as a refrigerant tends to deteriorate.

An object of an embodiment of the disclosure is to provide a working medium having a low global warming potential and a small temperature difference between a dew point and a boiling point at atmospheric pressure.

An object of another embodiment of the disclosure is to provide a composition for a thermal cycle system including the working medium, a thermal cycle device, and a thermal cycle method.

### Solution to Problem

The disclosure includes the following aspects.

<1>

A working medium containing 2,3,3,3-tetrafluoropropene, (Z)-1-chloro-2,3,3,3-tetrafluoropropene, and 1,1,1,2-tetrafluoroethane, in which a content of the 1,1,1,2-tetrafluoroethane is 15.0% by mass or less relative to a total content of the 2,3,3,3-tetrafluoropropene, the (Z)-1-chloro-2,3,3,3-tetrafluoropropene, and the 1,1,1,2-tetrafluoroethane, a content of the (Z)-1-chloro-2,3,3,3-tetrafluoropropene is 12.0% by mass or less relative to the total content of the 2,3,3,3-tetrafluoropropene, the (Z)-1-chloro-2,3,3,3-tetrafluoropropene, and the 1,1,1,2-tetrafluoroethane, and a content of the 2,3,3,3-tetrafluoropropene is 73.0% by mass or more relative to the total content of the 2,3,3,3-tetrafluoropropene, the (Z)-1-chloro-2,3,3,3-tetrafluoropropene, and the 1, 1,1,2-tetrafluoroethane.

<2>

The working medium according to <1> in which the total content of the 2,3,3,3-tetrafluoropropene, the (Z)-1-chloro-2,3,3,3-tetrafluoropropene, and the 1,1,1,2-tetrafluoroethane is 65.0% by mass or more relative to a total amount of the working medium.

<3>

The working medium according to <2>, further containing (E)-1,3,3,3-tetrafluoropropene.

<4>

The working medium according to <1> in which the total content of the 2,3,3,3-tetrafluoropropene, the (Z)-1-chloro-2,3,3,3-tetrafluoropropene, and the 1,1,1,2-tetrafluoroethane is 99.0% by mass or more relative to a total amount of the working medium.

<5>

The working medium according to <1>, in which the content of the 2,3,3,3-tetrafluoropropene is in a range of from 80.0 to 90.0% by mass relative to the total content of the 2,3,3,3-tetrafluoropropene, the (Z)-1-chloro-2,3,3,3-tetrafluoropropene, and the 1,1,1,2-tetrafluoroethane.

<6>

The working medium according to <I>, in which an oxygen concentration in a gas phase portion of the working medium at 25° C., is 0.315% by volume or less.

<7>

The working medium according to <6>, in which the content of the 2,3,3,3-tetrafluoropropene is 90.0% by mass or less relative to the total content of the 2,3,3,3-tetrafluoropropene, the (Z)-1-chloro-2,3,3,3-tetrafluoropropene, and the 1,1,1,2-tetrafluoroethane.

<8>

A composition for a thermal cycle system, including: the working medium according to any one of <1> to <7>; and a refrigerating machine oil.

<9>

The composition for a thermal cycle system according to <8>, in which the refrigerating machine oil is at least one selected from the group consisting of polyalkylene glycol oil, polyol ester oil, polyvinyl ether oil, and mineral oil.

<10>

The composition for a thermal cycle system according to <8> or <9>, in which a kinematic viscosity of the refrigerating machine oil at 40° C., is 700 mm²/s or less.

<11>

A thermal cycle device including:
the working medium according to any one of <1> to <7>;
a compressor that compresses vapor of the working medium;
a condenser that cools and liquefies the vapor of the working medium discharged from the compressor;
a pressure-reducing device that reduces a pressure of the working medium discharged from the condenser; and
an evaporator that heats the working medium discharged from the pressure-reducing device.
   <12>

The thermal cycle device according to <11>, in which an evaporation temperature of the working medium in the evaporator is controlled to be in a range of from −45 to 10° C.

<13>

The thermal cycle device according to <11>, in which an evaporation temperature of the working medium in the evaporator is controlled to be in a range of from −30 to 10° C.

<14>

The thermal cycle device according to <11>, in which an evaporation temperature of the working medium in the evaporator is controlled to be in a range of from −20 to 10° C.

<15>

The thermal cycle device according to <11>, in which at least a part of each surface that comes into contact with the working medium in components constituting the thermal cycle device includes at least one selected from the group consisting of copper and copper alloys.

<16>

A thermal cycle device including:
the working medium according to <7>;
a compressor that compresses vapor of the working medium;
a condenser that cools and liquefies the vapor of the working medium discharged from the compressor;
a pressure-reducing device that reduces a pressure of the working medium discharged from the condenser; and
an evaporator that heats the working medium discharged from the pressure-reducing device, in which
at least a part of each surface that comes into contact with the working medium in components constituting the thermal cycle device includes at least one selected from the group consisting of copper and copper alloys.
   <17>

The thermal cycle device according to <15> or <16>, in which the each of components is at least one selected from the group consisting of the compressor, the condenser, the evaporator, and a refrigerant pipe.

<18>

A thermal cycle method including:
compressing vapor of the working medium according to any one of <1> to <7>;
cooling and liquefying the vapor of the working medium;
reducing a pressure of the liquefied working medium; and
heating the pressure-reduced working medium.
   <19>

A working medium containing:
2,3,3,3-tetrafluoropropene, (E)-1,3,3,3-tetrafluoropropene, (Z)-1-chloro-2,3,3,3-tetrafluoropropene, and 1, 1,1,2-tetrafluoroethane,
in which a content of the 1,1,1,2-tetrafluoroethane is 15.0% by mass or less relative to a total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane;
a content of the (E)-1,3,3,3-tetrafluoropropene is 35.0% by mass or less relative to the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane;
a content of the (Z)-1-chloro-2,3,3,3-tetrafluoropropene is 12.0% by mass or less relative to the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane; and
a content of the 2,3,3,3-tetrafluoropropene is 38.0% by mass or more relative to the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane.
   <20>

The working medium according to <19>, in which the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane is 99.0% by mass or more relative to a total amount of the working medium.

<21>

The working medium according to <19> or <20>, in which an oxygen concentration in a gas phase portion of the working medium at 25° C., is 0.315% by volume or less.

### Advantageous Effects of Invention

According to an embodiment of the disclosure, there is provided a working medium having a low global warming potential and a small temperature difference between a dew point and a boiling point at atmospheric pressure.

According to another embodiment of the disclosure, a composition for a thermal cycle system including the working medium, a thermal cycle device, and a thermal cycle method are provided.

### BRIEF DESCRIPTION OF DRAWINGS

FIG. 1 is a schematic configuration diagram showing an example of a refrigeration cycle device.

FIG. 2 is a cycle diagram describing a state change of a working medium in a refrigeration cycle device on a pressure-enthalpy diagram.

### DESCRIPTION OF EMBODIMENTS

In the disclosure, a numerical range indicated using “to” means a range including numerical values listed before and after “to” as a minimum value and a maximum value, respectively.

In a numerical range described in stages in the disclosure, an upper limit value or a lower limit value listed in a certain numerical range may be replaced with an upper limit value or a lower limit value of another described numerical range in stages. In addition, in the numerical range described in the disclosure, an upper limit value or a lower limit value listed in a certain numerical range may be replaced with a value shown in Examples.

In the disclosure, a combination of two or more preferred embodiments is a more preferred embodiment.

In the disclosure, when there are a plurality of kinds of substances corresponding to each component, the amount of each component means the total amount of the plurality of kinds of substances unless otherwise specified.

In the disclosure, the pressure indicates an absolute pressure and is 101.3 kPa under atmospheric pressure.

In the disclosure, the saturated vapor pressure means a pressure of saturated vapor, and means a pressure that is an intersection of an isotherm and a saturated vapor line in a pressure-enthalpy diagram.

In the disclosure, the saturated liquid pressure means the pressure of the saturated liquid, and means the pressure at the intersection of the isotherm and the saturated liquid line in the pressure-enthalpy diagram.

### [Working Medium]

A working medium (hereinafter also referred to as a “first working medium”) according to a first embodiment of the disclosure contains 2,3,3,3-tetrafluoropropene (HFO-1234yf). (Z)-1-chloro-2,3,3,3-tetrafluoropropene (HCFO-1224yd(Z)), and 1,1,1,2-tetrafluoroethane (HFC-134a), the content of the HFC-134a is 15.0% by mass or less relative to the total content of the HFO-1234yf, the HCFO-1224yd(Z), and the HFC-134a, the content of the HCFO-1224yd(Z) is 12.0% by mass or less relative to the total content of the HFO-1234yf, the HCFO-1224yd(Z), and the HFC-134a, and the content of the HFO-1234 yfis 73.0% by mass or more relative to the total content of HFO-1234yf, HCFO-1224yd(Z), and the HFC-134a.

The working medium (hereinafter also referred to as a “second working medium”) according to a second embodiment of the disclosure contains HFO-1234yf, (E)-1,3,3,3-tetrafluoropropene (HFO-1234ze(E)), HCFO-1224yd(Z), and HFC-134a, the content of the HFC-134a is 15.0% by mass or less relative to the total content of the HFO-1234yf, the HFO-1234ze(E), the HCFO-1224yd(Z), and the HFC-134a, the content of the HFO-1234ze(E) is 35.0% by mass or less relative to the total content of HFO-1234yf, HFO-1234ze(E), HCFO-1224yd(Z), and HFC-134a, the content of HCFO-1224yd(Z) is 12.0% by mass or less relative to the total content of HFO-1234yf, HFO-1234ze(E), HCFO-1224yd(Z), and HFC-134a, and the content of HFO-1234yf is 38.0% by mass or more relative to the total content of HFO-1234yf, HFO-1234ze(E), HCFO-1224yd(Z), and HFC-134a.

In the disclosure, the working medium means a medium that transfers heat, and is a concept including a refrigerant composition and a heat medium composition. The refrigerant composition is a medium mainly responsible for cooling the heat source, but may be used as a medium responsible for heating at the same time. The heat medium composition is a medium mainly responsible for heating, but may be used as a medium responsible for cooling a heat source at the same time.

The working medium of the disclosure is preferably for thermal cycling. Specifically, the working medium of the disclosure is preferably used in a thermal cycle system in which a series of changes such as applying a state change using heat absorption and heat dissipation and returning to an initial state again occurs.

The working medium of the disclosure has a low global warming potential (GWP) and a small temperature difference between a dew point and a boiling point at atmospheric pressure. The reason for this is not clear, but it is presumed as follows.

The HFO-1234yf contained in a first working medium has a boiling point of −29.49° C. and a GWP of 1 or less, but is mildly flammable.

HCFO-1224yd(Z) contained in the first working medium has a low GWP of 1 or less and is non-flammable, but has a boiling point slightly higher than that of HFO-1234yf, that is, 14.62° C.

The HFC-134a contained in the first working medium has a boiling point close to that of the HFO-1234yf, that is −26.07° C., and is non-flammable, but has a high GWP of 1.300.

The present inventor has found that by mixing HFO-1234yf, HCFO-1224yd(Z), and HFC-134a at a specific ratio, it is possible to achieve both suppression of a decrease in GWP and suppression of an increase in the temperature difference between the dew point and the boiling point at atmospheric pressure.

Specifically, HFO-1234yf has a low boiling point and a low GWP, but has mild flammability, and therefore, it was considered that, while using HFO-1234yf as the main component, flammability can be reduced by combining it with an additional non-flammable component in order to suppress flammability. However, since the temperature glide increases as the boiling point of the additional component is different from that of the HFO-1234yf, it is desirable to combine HFC-134a, which has a boiling point close to that of HFO-1234yf. However, since the HFC-134a has a high GWP, it is difficult to increase the content of the HFC-134a from the viewpoint of decreasing the GWP of the working medium. Therefore, it has been found that by further combining HCFO-1224yd(Z) which is non-flammable and has a low GWP, a working medium having a low GWP and a small temperature difference between the dew point and the boiling point at atmospheric pressure can be obtained.

Specifically, the present inventor has found that a GWP of 200 or less and a temperature difference of 6.50° C. or less between the dew point and the boiling point at atmospheric pressure can be achieved in the first working medium.

Further, the HFO-1234ze(E) contained in the second working medium has a boiling point of −18.97° C., and a GWP of 1 or less, but is mildly flammable. The present inventor has found that even when a part of the HFO-1234yf is replaced with the HFO-1234ze(E), a working medium having a low GWP and a small temperature difference between the dew point and the boiling point at atmospheric pressure can be obtained. Since HFO-1234ze (Z), which is an isomer of HFO-1234ze(E), has a boiling point slightly higher than that of HFC-134a, the present inventor focused on HFO-1234ze(E).

Specifically, the present inventor has found that a GWP of 200 or less and a temperature difference of 6.50° C. or less between the dew point and the boiling point at atmospheric pressure can be achieved in the second working medium.

Meanwhile, in the working medium described in Patent Literature 1, since the content of HCFO-1224yd is 30% by mass or more, the azeotropicity is poor, and there is a tendency for the temperature glide to become high. In addition, since the content of the HFO-1234yf is 70% by mass or less, the volumetric capacity becomes low, and there is a tendency for the performance as a refrigerant to deteriorate.

Hereinafter, each component included in the working medium of the disclosure will be described in detail.

### <<First Working Medium>

The first working medium contains HFO-1234yf, HCFO-1224yd(Z), and HFC-134a.

Other components other than the HFO-1234yf, the HCFO-1224yd(Z), and the HFC-134a may affect the GWP of the working medium and the temperature difference between the dew point and the boiling point at atmospheric pressure. Therefore, the content of other components is preferably small.

From the above viewpoint, in the first working medium, the total content of the HFO-1234yf, the HCFO-1224yd(Z), and the HFC-134a is preferably 65.0% by mass or more, more preferably 80.0% by mass or more, still more preferably 90.0% by mass or more, particularly preferably 99.0% by mass or more, and most preferably 99.5% by mass or more relative to the total amount of the working medium. The upper limit value of the total content of the HFO-1234yf, the HCFO-1224yd(Z), and the HFC-134a is not particularly limited, and may be 100% by mass.

In the thermal cycle device or the thermal cycle method, from the viewpoint of lowering the discharge temperature while securing the evaporation pressure when the pressure-reduced working medium is heated at the evaporation temperature of from −40 to 10° C., the total content of the HFO-1234yf, the HCFO-1224yd(Z), and the HFC-134a is preferably 99.0% by mass or more, more preferably 99.5% by mass or more, and may be 100% by mass relative to the total amount of the working medium.

### <HFO-1234yf>

The first working medium contains HFO-1234yf.

In the first working medium, the content of the HFC-134a is 15.0% by mass or less relative to the total content of the HFO-1234yf, the HCFO-1224yd(Z), and the HFC-134a, and the content of the HCFO-1224yd(Z) is 12.0% by mass or less relative to the total content of the HFO-1234yf, the HCFO-1224yd(Z), and the HFC-134a. The first working medium has a low GWP and a small temperature difference between the dew point and the boiling point at atmospheric pressure because the contents of the HFC-134a and the HCFO-1224yd(Z) are within the above ranges.

The content of the HFO-1234yf is 73.0% by mass or more relative to the total content of the HFO-1234yf, the HCFO-1224yd(Z), and the HFC-134a in order to set the contents of the HFC-134a and HCFO-1224yd(Z) within the above ranges.

As described above, the HFO-1234yf has a low boiling point of −29.49° C., and is excellent in performance as a working medium. Since the HFO-1234yf is a main component (component having the largest content) among the three components of the HFO-1234vf, the HCFO-1224yd(Z), and the HFC-134a, the first working medium is excellent in performance as a working medium.

When the content of the HFO-1234yf relative to the total content is 73.0% by mass or more, the volumetric capacity (CAP) tends to be improved, and the discharge temperature tends to decrease. Specifically, when the content of the HFO-1234yf relative to the total content is 73.0% by mass or more, the CAP based on the HFC-134a tends to become 0.830 or more, and the discharge temperature tends to decrease by 5.50° C. or more relative to the discharge temperature of the HFC-134a.

The upper limit value of the content of the HFO-1234yf relative to the total content is not particularly limited, but is preferably 90.0% by mass or less. When the content of the HFO-1234yf relative to the total content is 90.0% by mass or less, the coefficient of performance (COP) tends to be improved, the refrigeration effect tends to be improved, and the heat of combustion (HOC) tends to decrease.

In particular, the content of the HFO-1234yf is preferably in a range of from 80.0 to 90.0% by mass relative to the total content of the HFO-1234yf, the HCFO-1224yd(Z), and the HFC-134a. When the content of the HFO-1234yf relative to the total content is 80.0% by mass or more, the discharge temperature tends to decrease by 6.50° C. or more relative to the discharge temperature of the HFC-134a. In addition, when the content of the HFO-1234yf relative to the total content is 90.0% by mass or less, the HOC tends to be 10.350 MJ/kg or less. Furthermore, when the content of the HFO-1234yf relative to the total content is in a range of from 80.0 to 90.0% by mass, the temperature difference between the dew point and the boiling point at atmospheric pressure tends to be smaller.

When the content of the HFO-1234yf is within the above range, the heat of combustion (HOC) of the working medium is reduced, and in the thermal cycle device or the thermal cycle method, when the pressure-reduced working medium is heated at an evaporation temperature of from −40 to 10° C., there is a tendency that the discharge temperature can be lowered while an evaporation pressure is secured.

### <HCFO-1224yd(Z)>

The first working medium contains HCFO-1224yd(Z).

The content of HCFO-1224yd(Z) is 12.0% by mass or less relative to the total content of the HFO-1234yf, the HCFO-1224yd(Z), and the HFC-134a. Since the first working medium contains HCFO-1224yd(Z), the content of the HCFO-1224yd(Z) is more than 0% by mass.

When the content of HCFO-1224yd(Z) relative to the total content is 12.0% by mass or less, the temperature difference between the dew point and the boiling point at atmospheric pressure tends to be small, specifically, 6.50° C. or less. When the content of HCFO-1224yd(Z) relative to the total content is 12.0% by mass or less, CAP tends to be improved, and specifically, tends to become 0.830 or more.

From the viewpoint of further reducing the temperature difference between the dew point and the boiling point at atmospheric pressure, the content of HCFO-1224yd(Z) is preferably 10.0% by mass or less relative to the total content of the HFO-1234yf, the HCFO-1224yd(Z), and the HFC-134a.

When the content of HCFO-1224yd(Z) relative to the total content is 10.0% by mass or less, the temperature difference between the dew point and the boiling point at atmospheric pressure tends to be 5.50° C. or less. When the content of HCFO-1224yd(Z) relative to the total content is 10.0% by mass or less, CAP tends to become 0.845 or more.

The content of HCFO-1224yd(Z) is more than 0% by mass, and preferably 3.0% by mass or more. When the content of HCFO-1224yd(Z) is 3.0% by mass or more, the COP tends to be improved, the refrigeration effect tends to be improved, and the HOC tends to decrease.

### <HFC-134a>

The first working medium contains HFC-134a.

The content of the HFC-134a is 15.0% by mass or less relative to the total content of the HFO-1234yf, the HCFO-1224yd(Z), and the HFC-134a. Since the first working medium includes the HFC-134a, the content of the HFC-134a is more than 0% by mass.

When the content of the HFC-134a relative to the total content is 15.0% by mass or less, the GWP tends to decrease, and specifically, the GWP tends to become 200 or less.

From the viewpoint of further reducing the GWP, the content of the HFC-134a is more preferably 11.0% by mass or less relative to the total content of the HFO-1234yf, the HCFO-1224yd(Z), and the HFC-134a.

When the content of the HFC-134a relative to the total content is 11.0% by mass or less, the GWP tends to further decrease, and specifically, the GWP tends to become 150 or less.

The content of the HFC-134a relative to the total content is more than 0% by mass, and preferably 3.0% by mass or more. When the content of the HFC-134a relative to the total content is 3.0% by mass or more, the HOC tends to decrease.

In addition to the HFO-1234yf, the HCFO-1224yd(Z), and the HFC-134a, the first working medium may contain a compound usually used for the working medium as an optional component. Examples of the optional component include hydrofluorocarbon (HFC) and hydrofluoroolefin (HFO) other than the HFO-1234yf, the HCFO-1224yd(Z), and the HFC-134a. The optional component may be only one kind or two or more kinds.

Examples of the HFC which is an optional component include difluoromethane (HFC-32), fluoroethane (HFC-161), 1,1-difluoroethane (HFC-152a), 1,1,1-trifluoroethane (HFC-143a), 1,1,2,2-tetrafluoroethane (HFC-134), 1,1,1,2,2-pentafluoroethane (HFC-125), pentafluoropropane, hexafluoropropane, 1,1,1,2,3,3,3-heptafluoropropane (HFC-227ea), pentafluorobutane, and heptafluorocyclopentane.

Examples of the HFO which is an optional component include trifluoroethylene (HFO-1123), 1,1-difluoroethylene (HFO-1132a), (Z)-1,2-difluoroethylene (HFO-1132 (Z)), (E)-1,2-difluoroethylene (HFO-1132 (E)), 2-fluoropropene (HFO-1261yf), 1,1,2-trifluoropropene (HFO-1243yc), (Z)-1,3,3,3-tetrafluoropropene (HFO-1234ze (Z)). (E)-1,3,3,3-tetrafluoropropene (HFO-1234ze(E)), 1,1,2,3,3-pentafluoropropene (HFO-1225yc). 1,2,3,3,3-pentafluoropropene (HFO-1225ve), 3,3,3-trifluoropropene (HFO-1243zf), 2,4,4,4-tetrafluorobutene (HFO-1354yf), (Z)-1,1,1,4,4,4-hexafluorobutene (HFO-1336mzz(Z)), and (E)-1,1,1,4,4,4-hexafluorobutene (HFO-1336mzz(E)).

Examples of the HCFO which is an optional component include (E)-1-chloro-2,3,3,3-tetrafluoropropene (HCFO-1224yd(E)), 2-chloro-1,1,3,3-tetrafluoropropene (HCFO-1224xc), 2-chloro-1,3,3,3-tetrafluoropropene (HCFO-1224xe), 1-chloro-1,2-difluoroethylene (HCFO-1122). 1-chloro-1,2-difluoroethylene (HCFO-1122a), (E)-1-chloro-3,3,3-trifluoropropene (HCFO-1233zd(E)), (Z)-1-chloro-3,3,3-trifluoropropene (HCFO-1233zd(Z)), 2-chloro-1,1,3-trifluoropropene (HCFO-1233xc), and 2-chloro-3,3,3-trifluoropropene (HCFO-1233xf).

Examples of the hydrocarbon which is an optional component include propylene, propane, cyclopropane, butane, isobutane, pentane, and isopentane.

Examples of CFO which is an optional component include 1,1-dichloro-2,3,3,3-tetrafluoropropene (CFO-1214ya). 1,3-dichloro-1,2,3,3-tetrafluoropropene (CFO-1214yb), and 1,2-dichloro-1,2-difluoroethylene (CFO-1112).

When the first working medium contains optional components, the content of the optional component is preferably 35.0% by mass or less, more preferably 20.0% by mass or less, still more preferably 10.0% by mass or less, particularly preferably 5.0% by mass or less, extremely preferably 1.0% by mass or less, and most preferably 0.5% by mass or less relative to the total amount of the working medium.

When the first working medium contains optional components, the optional components preferably include the HFO-1234ze(E). That is, the first working medium preferably further contains the HFO-1234ze(E).

The content of water in the first working medium is preferably 20 ppm by mass or less, and particularly preferably 15 ppm by mass or less relative to the total amount of the working medium as a moisture content measured by Karl Fischer coulometric titration method. When the content of water is 20 ppm by mass or less, freezing in the capillary tube of the thermal cycle device, hydrolysis of the working medium and the refrigerating machine oil, material deterioration due to acid components generated in the device, occurrence of contamination, and the like are suppressed.

The content of air in the gas phase portion of the first working medium at 25° C., is preferably 3.5% by volume or less, more preferably 2.5% by volume or less, still more preferably 2.0% by volume or less, and particularly preferably 1.5% by volume or less as an air concentration measured by gas chromatogram. When the content of air is 3.5% by volume or less, the occurrence of discoloration and rust on a metal surface which is a surface in contact with a working medium in a thermal cycle device is suppressed. This is presumed to be due to the suppression of the decomposition of metal caused by the reaction of oxygen in the air with the working medium or the refrigerating machine oil.

Therefore, the content of oxygen in the gas phase portion of the working medium at 25° C., is preferably 0.735% by volume or less, more preferably 0.525% by volume or less, still more preferably 0.420% by volume or less, and particularly preferably 0.315% by volume or less as the oxygen concentration measured by gas chromatogram. When the content of oxygen is 0.735% by volume or less, the occurrence of discoloration and rust on a metal surface which is a surface in contact with a working medium in a thermal cycle device is suppressed.

In particular, when the oxygen concentration of the gas phase portion of the working medium at 25° C., is within the above range, there is an advantage that the occurrence of discoloration and rust on the surface is suppressed even for copper and copper alloys having excellent heat transfer performance, conductivity, strength, corrosion resistance, flexibility, workability, and installability.

Copper and copper alloys are widely used in components constituting a thermal cycle device such as refrigeration and air-conditioning equipment because of their excellent properties. Examples of such components include a compressor, a condenser, an evaporator, and a refrigerant pipe.

However, when the surfaces of copper and copper alloy are discolored and altered, the above-mentioned excellent performance may be lost.

Since the refrigerant pipe is required to have flexibility and strength, the entire refrigerant pipe is often made of copper and a copper alloy. When the surfaces of copper and copper alloy are discolored and altered, there is a fear that the flexibility and strength of the refrigerant pipe decrease.

In condensers and evaporators, copper or copper alloy with high thermal conductivity is used from the viewpoint of heat transfer performance, and they are often entirely composed of copper and copper alloy. From the viewpoint of further improving heat transfer performance, the surfaces of the condenser and the evaporator may be grooved. When the surface of copper or copper alloy becomes discolored and rust is generated, there is concern about a decrease in the heat transfer performance of the condenser and evaporator.

The compressor often uses copper or copper alloy in the winding portion and the connection piping portion inside the compressor. When the surface of the winding portion is discolored and altered, there is a concern that the insulation property or the conductivity deteriorates. As a result, the performance and reliability of the compressor deteriorate, and the working medium, the composition for a thermal cycle system, and the like may leak from the compressor. When the working medium, the composition for a thermal cycle system, or the like leaks, the refrigerant composition in the thermal cycle device may change.

From such a viewpoint, in the thermal cycle device, it is preferable to suppress the occurrence of discoloration and rust on the surfaces of copper and the copper alloy.

From the viewpoint of further suppressing the occurrence of discoloration and rust on the surfaces of copper and the copper alloy, when the oxygen concentration in the gas phase portion of the working medium at 25° C., is 0.315% by volume or less, the content of HFO-1234yf is preferably 90.0% by mass or less, and more preferably 87.0% by mass or less relative to the total content of the HFO-1234yf, the HCFO-1224yd(Z), and the HFC-134a.

The first working medium may contain unavoidable components such as impurities produced as by-products during production of specific components and the like, and solvents used during production. From the viewpoint of securing stability, the total content of these unavoidable components is preferably 1.5% by mass or less, more preferably 1.3% by mass or less, and still more preferably 1.0% by mass or less relative to the total amount of the working medium. From the viewpoint of simplifying the purification step in the production of the specific components and the like, the total content of the unavoidable components may be 50.0 ppm by mass or more, or may be 100.0 ppm by mass or more.

Examples of the unavoidable components include 1,1,2,2,3-pentafluoro-1,3-dichloropropane (HCFC-225cb), 1,1,1,2-tetrafluoropropane (HFC-254eb), 1,3,3,3-tetrafluoropropane (HFC-254fb), 1,1,2,3-tetrafluorobutane (HFC-374pee), CFO-1214ya, HCFO-1224yd(E), (Z)-2-chloro-1,3,3,3-tetrafluoropropene (HCFO-1224xe(Z)). (E)-2-chloro-1,3,3,3-tetrafluoropropene (HCFO-1224xe (E)). HCFO-1233xf. HFO-1234yf, HFO-1234ze (Z), HFO-1354yf, HCFO-1233zd(E). HCFO-1233zd(Z), HCFO-1233xc, fluorocarbons represented by C₄H₄F₄, 2-chloro-1, 1,1,2-tetrafluoropropane (HCFC-244bb), HFC-245fa. 2-chloro-1,1,3,3,3-pentafluoro-1-propene (CFO-1215xc), 3,3-dichloro-1,1,1,2,2-pentafluoropropane (HCFC-225ca), 1,1,1,2,2,3,3-heptafluoropropane (FC-227ca), methanol, ethanol, acetone, chloroform, and hexane.

### <<Second Working Medium>>

The second working medium contains the HFO-1234yf, the HFO-1234ze(E), the HCFO-1224yd(Z), and the HFC-134a.

Other components other than the HFO-1234yf, the HFO-1234ze(E), the HCFO-1224yd(Z), and the HFC-134a may affect the GWP of the working medium and the temperature difference between the dew point and the boiling point at atmospheric pressure. Therefore, the content of other components is preferably small.

From the above viewpoint, in the second working medium, the total content of the HFO-1234yf, the HFO-1234ze(E), the HCFO-1224yd(Z), and the HFC-134a is preferably 80.0% by mass or more, more preferably 85.0% by mass or more, still more preferably 90.0% by mass or more, and particularly preferably 99.0% by mass or more relative to the total amount of the working medium. The upper limit value of the total content of the HFO-1234yf, the HFO-1234ze(E), the HCFO-1224yd(Z), and the HFC-134a is not particularly limited, and may be 100% by mass.

### <HFO-1234yf>

The second working medium contains the HFO-1234yf.

In the second working medium, the content of the HFC-134a is 15.0% by mass or less relative to the total content of the HFO-1234yf, the HFO-1234ze(E), the HCFO-1224yd(Z), and the HFC-134a, and the content of the HCFO-1224yd(Z) is 12.0% by mass or less relative to the total content of the HFO-1234yf, the HFO-1234ze(E), the HCFO-1224yd(Z), and the HFC-134a. The second working medium has a low GWP and a small temperature difference between the dew point and the boiling point at atmospheric pressure because the contents of the HFC-134a and the HCFO-1224yd(Z) are within the above ranges.

The content of the HFO-1234yf is 38.0% by mass or more, and preferably 45.0% by mass or more relative to the total content of the HFO-1234yf, the HFO-1234ze(E), the HCFO-1224yd(Z), and the HFC-134a in order to set the contents of the HFC-134a and HCFO-1224yd(Z) within the above ranges.

As described above, the HFO-1234yf has a low boiling point of −29.49° C., and is excellent in performance as a working medium. Since the HFO-1234yf is a main component (component having the largest content) among the four components that are HFO-1234yf, HFO-1234ze(E), HCFO-1224yd(Z), and HFC-134a, the second working medium is excellent in performance as a working medium.

When the content of the HFO-1234yf is 38.0% by mass or more relative to the total content, the CAP tends to be improved, and the discharge temperature tends to decrease.

The upper limit value of the content of the HFO-1234yf is not particularly limited, but is preferably 78.0% by mass. When the content of the HFO-1234yf relative to the total content is 78.0% by mass or less, the COP tends to be improved, the refrigeration effect tends to be improved, and the HOC tends to decrease.

### <HFO-1234ze(E)>

The second working medium contains the HFO-1234ze(E).

The content of the HFO-1234ze(E) is 35.0% by mass or less, and preferably 25.0% by mass or less relative to the total content of the HFO-1234yf, the HFO-1234ze(E), the HCFO-1224yd(Z), and the HFC-134a in order to set the contents of the HFC-134a and HCFO-1224yd(Z) within the above ranges.

Since the second working medium includes the HFO-1234ze(E), the content of the HFO-1234ze(E) is more than 0% by mass.

As described above, the HFO-1234ze(E) has a low boiling point of −18.97° C., and is excellent in performance as a working medium. In addition, the HFO-1234ze(E) has a GWP of 1 or less, and particularly has low flammability among the categories of mildly flammable refrigerants. From these viewpoints, the content of the HFO-1234ze(E) is preferably 5.0% by mass or more.

### <HCFO-1224yd(Z)>

The second working medium contains HCFO-1224yd(Z).

The content of HCFO-1224yd(Z) is 12.0% by mass or less relative to the total content of the HFO-1234yf, the HFO-1234ze(E), the HCFO-1224yd(Z), and the HFC-134a. Since the second working medium contains HCFO-1224yd(Z), the content of the HCFO-1224yd(Z) relative to the total content is more than 0% by mass.

When the content of HCFO-1224yd(Z) relative to the total content is 12.0% by mass or less, the temperature difference between the dew point and the boiling point at atmospheric pressure tends to be small, specifically, 6.50° C. or less.

From the viewpoint of further reducing the temperature difference between the dew point and the boiling point at atmospheric pressure, the content of HCFO-1224yd(Z) is preferably 10.0% by mass or less relative to the total content of the HFO-1234yf, the HFO-1234ze(E), the HCFO-1224yd(Z), and the HFC-134a.

When the content of HCFO-1224yd(Z) relative to the total content is 10.0% by mass or less, the temperature difference between the dew point and the boiling point at atmospheric pressure tends to be 5.50° C. or less.

The content of the HCFO-1224yd(Z) relative to the total content is more than 0% by mass, and preferably 3.0% by mass or more. When the content of the HCFO-1224yd(Z) relative to the total content is 3.0% by mass or more, the COP tends to be improved, the refrigeration effect tends to be improved, and the HOC tends to decrease.

### <HFC-134a>

The second working medium contains HFC-134a.

The content of the HFC-134a is 15.0% by mass or less relative to the total content of the HFO-1234yf, the HFO-1234ze(E), the HCFO-1224yd(Z), and the HFC-134a. Since the second working medium contains HFC-134a, the content of the HFC-134a relative to the total content is more than 0% by mass.

When the content of the HFC-134a relative to the total content is 15.0% by mass or less, the GWP tends to decrease, and specifically, the GWP tends to become 200 or less.

From the viewpoint of further reducing the GWP, the content of the HFC-134a is more preferably 11.0% by mass or less relative to the total content of the HFO-1234yf, the HFO-1234ze(E), the HCFO-1224yd(Z), and the HFC-134a.

When the content of the HFC-134a relative to the total content is 11.0% by mass or less, the GWP tends to further decrease, and specifically, the GWP tends to become 150 or less.

The content of the HFC-134a relative to the total content is more than 0% by mass, and preferably 3.0% by mass or more. When the content of the HFC-134a relative to the total content is 3.0% by mass or more, the HOC tends to decrease.

In addition to the HFO-1234yf, the HFO-1234ze(E), the HCFO-1224yd(Z), and the HFC-134a, the second working medium may contain a compound usually used for the working medium as an optional component. Examples of the optional component include optional components (here, the HFO-1234ze(E) is excluded) that may be contained in the first working medium.

When the second working medium contains optional components, the content of the optional component is preferably 10.0% by mass or less, more preferably 8.0% by mass or less, still more preferably 5.0% by mass or less, and particularly preferably 1.0% by mass or less relative to the total amount of the working medium.

The contents of water, air, and oxygen in the second working medium are the same as the contents of water, air, and oxygen in the first working medium.

In addition, the unavoidable component that may be contained in the second working medium is the same as the unavoidable component that may be contained in the first working medium.

### <Cycle Performance>

Cycle performance, a property required when applying a working medium to a thermal cycle system, can be evaluated in terms of coefficient of performance (in the disclosure, also referred to as “COP”) and capacity per unit volume (in the disclosure, also referred to as “CAP”). When the thermal cycle system is a refrigeration cycle system, the capacity is a refrigeration capacity. The evaluation items when the working medium is applied to the refrigeration cycle system include temperature glide (evaporation glide), condensation pressure, evaporation pressure, and discharge temperature in the evaporator in addition to the above cycle performance. Specifically, for example, each item is calculated by a method described later using a reference refrigeration cycle under a temperature condition described below. The evaporation glide is evaluated by an absolute value. The CAP, the COP, the condensation pressure, and the evaporation pressure are evaluated in terms of relative values based on the value of the HFC-134a. The discharge temperature is evaluated by a difference based on the value of the HFC-134a and a reduction rate.

### (Temperature Condition of Reference Refrigeration Cycle)

Evaporation temperature: 0° C. (here, in the case of a non-azeotropic mixture, since the average temperature of the evaporation start temperature and the evaporation completion temperature is obtained, the evaporation temperature is calculated as follows: evaporation temperature=(evaporation start temperature+evaporation completion temperature)/2).

Condensation temperature: 45° C. (here, in the case of the non-azeotropic mixture, since the average temperature of the condensation start temperature and the condensation completion temperature is obtained, the condensation temperature is calculated as follows: condensation temperature=(condensation start temperature+condensation completion temperature)/2).
Subcooling degree (SC): 0° C.
Superheating degree (SH): 5° C.
Compressor efficiency: 0.7

### (Refrigeration Cycle System)

As an example of the thermal cycle system, a refrigeration cycle system will be described.

The refrigeration cycle system is a system in which a working medium removes heat energy from a load fluid in an evaporator to cool the load fluid to a lower temperature.

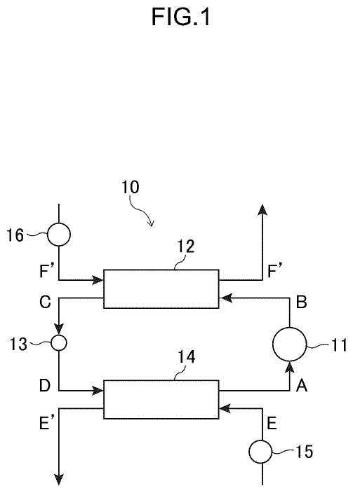

FIG. 1 is a schematic configuration diagram showing an example of the refrigeration cycle system according to the disclosure. The refrigeration cycle system 10 is a system schematically configured to include: a compressor 11 that compresses working medium vapor A into working medium vapor B having a high temperature and a high pressure: a condenser 12 that cools the working medium vapor B discharged from the compressor 11 and liquefies the working medium vapor B into a working medium C having a low temperature and a high pressure: an expansion valve 13 that expands the working medium C discharged from the condenser 12 to form a working medium D having a low temperature and a low pressure: an evaporator 14 that heats the working medium D discharged from the expansion valve 13 to form the working medium vapor A having a high temperature and a low pressure: a pump 15 that supplies a load fluid E to the evaporator 14; and a pump 16 that supplies a fluid F to the condenser 12.

In the refrigeration cycle system 10, the following cycles (i) to (iv) are repeated.

(i) The working medium vapor A discharged from the evaporator 14 is compressed by the compressor 11 into the working medium vapor B having a high temperature and a high pressure (hereinafter referred to as an “AB process”).

(ii) The working medium vapor B discharged from the compressor 11 is cooled by the fluid F in the condenser 12 and liquefied to obtain the working medium C having a low temperature and a high pressure. At this time, the fluid F is heated to become a fluid F′, and is discharged from the condenser 12 (hereinafter referred to as a “BC process”).

(iii) The working medium C discharged from the condenser 12 is expanded by the expansion valve 13 to become the working medium D having a low temperature and a low pressure (hereinafter referred to as a “CD process”).

(iv) The working medium D discharged from the expansion valve 13 is heated by the load fluid E in the evaporator 14 to become the working medium vapor A having a high temperature and a low pressure. At this time, the load fluid E is cooled to become a load fluid E′, and is discharged from the evaporator 14 (hereinafter referred to as a “DA process”).

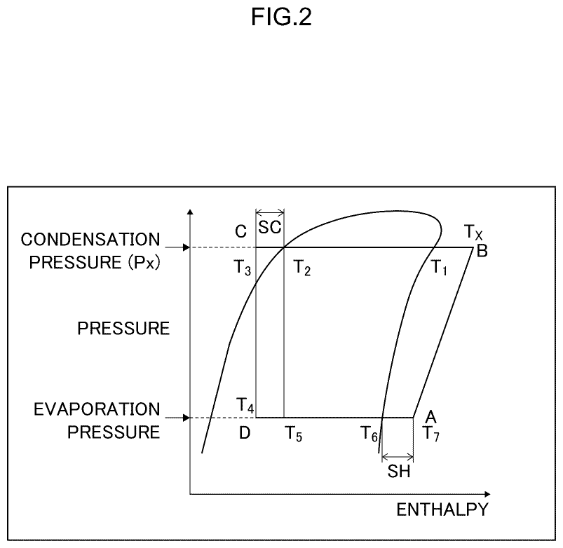

The refrigeration cycle system 10 is a cycle system including an adiabatic/isentropic change, an isenthalpic change, and an isobaric change. The state change of the working medium is described on the pressure-enthalpy line (curve)diagram shown in FIG. 2, and A, B, C, and D can be represented as vertices.

The AB process is a process in which adiabatic compression is performed in the compressor 11 to convert the working medium vapor A having a low temperature and a low pressure into the working medium vapor B having a high temperature and a high pressure, and is indicated by an AB line in FIG. 2. As described later, the working medium vapor A is introduced into the compressor 11 in a superheated state, and the obtained working medium vapor B is also the vapor in the superheated state. The compressor suction gas density is the density (ρs) in the state A in FIG. 2. The compressor discharge gas temperature (discharge temperature) is the temperature (Tx) in the state B in FIG. 2, and is the maximum temperature in the refrigeration cycle. The compressor discharge pressure (discharge pressure) is the pressure (Px) in the state B in FIG. 2, and is the maximum pressure in the refrigeration cycle. Since the BC process is isobaric cooling, the discharge pressure shows the same value as the condensation pressure (Pc). Therefore, in FIG. 2, the condensation pressure is indicated as Px for convenience.

The BC process is a process in which isobaric cooling is performed in the condenser 12 to turn the working medium vapor B having a high temperature and a high pressure into the working medium C having a low temperature and a high pressure, and is indicated by a BC line in FIG. 2. The pressure at this time is the condensation pressure. Among the intersections of the pressure-enthalpy line and the BC line, the intersection T1 on the high enthalpy side is the condensation start temperature, and the intersection T2 on the low enthalpy side is the condensation completion temperature. Here, the temperature gradient in the condenser when the working medium is a non-azeotropic mixed medium is indicated as a difference between T1 and T2.

The CD process is a process in which isenthalpic expansion is performed by the expansion valve 13 to convert the working medium C having a low temperature and a high pressure into the working medium D having a low temperature and a low pressure, and is indicated by a CD line in FIG. 2. When the temperature of the working medium C having a low temperature and a high pressure is represented by T3, T2-T3 is the subcooling degree (SC) of the working medium in the cycles of (i) to (iv).

The DA process is a process in which isobaric heating is performed in the evaporator 14 to return the working medium D having a low temperature and a low pressure to the working medium vapor A having a high temperature and a low pressure, and is indicated by a DA line in FIG. 2. The pressure at this time is the evaporation pressure. Among the intersections of the pressure-enthalpy line and the DA line, the intersection T6 on the high enthalpy side is the evaporation completion temperature, and the intersection T4 on the low enthalpy side is the evaporation start temperature. Here, the temperature gradient in the evaporator when the working medium is a non-azeotropic mixed medium is indicated as a difference between T6 and T4. When the temperature of the working medium vapor A is represented by T7, T7-T6 is the superheating degree (SH) of the working medium in the cycles (i) to (iv). In addition, T4 represents the temperature of the working medium D.

The CAP and the COP of the working medium are obtained from the following Formulas (11), (12), (13), and (14), respectively, using the enthalpies at each state of the working medium A (after evaporation, having a low temperature and a low pressure), B (after compression, having a high temperature and a high pressure), C (after condensation, having a low temperature and a high pressure), and D (after expansion, having a low temperature and a low pressure), denoted as hA, hB, hC, and hD respectively, and the mass circulation rate of the working medium, qmr. It is assumed that there is no pressure loss in the piping and the heat exchanger.

When the loss work of the compressor is applied as heat to the working medium, using the compressor efficiency n, the working medium vapor B′ after the AB process is expressed by the following equation using hA, hB and n.

$${hB}^{′} = hA + ( hB - hA ) / η$$

Cycle performance of the working medium is determined by performing a refrigeration cycle theoretical calculation of the working medium under the temperature condition of the reference refrigeration cycle using National Institute of Science and Technology (NIST) Reference Fluid Thermodynamic and Transport Properties Database (REFPROP 10.0).

$$CAP = ( ha - hD ) \times ρ s = wr \times ρ s \qquad ( 11 )$$

$$COP = Q / P = qmr ( hA - hD ) / qmr ( hB - hA ) = ( hA - hD ) / ( hB - hA ) \qquad ( 12 )$$

$$Q = qmr ( hA - hD ) \qquad ( 13 )$$

$$P = qmr ( hB - hA ) \qquad ( 14 )$$

In consideration of compressor efficiency, COP and P are expressed by the following equations.

$$COP = Q / P = ( hA - hD ) / ( {hB}^{′} - hA ) \qquad ( 15 )$$

$$P = qmr ( {hB}^{′} - hA ) \qquad ( 16 )$$

### <Temperature Glide>

The temperature glide is an index for measuring the difference in composition between the liquid phase and the gas phase in the working medium of the mixture. The temperature glide is defined as the property of the evaporation in a heat exchanger, for example an evaporator, or the condensation in a condenser, of which the start temperature and the completion temperature are different. In the disclosure, a property that the start temperature and the completion temperature of evaporation in an evaporator are different is referred to as “evaporation glide”. In addition, a property that the start temperature and the completion temperature of condensation in the condenser are different is referred to as “condensation glide”. The evaporation glide and the condensation glide are collectively referred to as “temperature glide”.

In the azeotropic mixed medium, the temperature glide is 0, and in the quasi-azeotropic mixture such as R410A, the temperature glide is extremely close to 0.

When the temperature glide is large, for example, the inlet temperature in the evaporator decreases, and accordingly, the possibility of frosting increases, which is a problem. Furthermore, in the thermal cycle system, in order to improve the heat exchange efficiency, it is common to use counterflow between the working medium flowing through the heat exchanger and a heat source fluid such as water or air, and since the temperature difference of the heat source fluid is small in the stable operation state, it is difficult to obtain an energy efficient thermal cycle system in the case of a non-azeotropic mixed medium having a large temperature glide. Therefore, when the mixture is used as a working medium, a working medium having an appropriate temperature glide is desired.

From the above viewpoint, the evaporation glide of the working medium of the disclosure is preferably 5.0° C. or lower, more preferably 4.5° C. or lower, and still more preferably 4.0° C. or lower.

In the working medium of the disclosure, the temperature difference between the dew point and the boiling point at atmospheric pressure is preferably 6.50° C. or less, and more preferably 5.50° C. or less, from the viewpoint of suppressing an increase in temperature glide. The lower limit value of the temperature difference is not particularly limited, but may be 0.50° C. or more, or 1.00° C. or more.

The dew point and the boiling point are values at atmospheric pressure (101.325 kPa).

### <Global Warming Potential (GWP)>

In the disclosure, unless otherwise specified, the GWP is based on the 100-year value from the Fifth Assessment Report (AR5) of the Intergovernmental Panel on Climate Change (IPCC).

The GWP in the mixture is a weighted average by composition mass. In considering the GWP in the mixture, the GWP of 1 or less is calculated as 1.

### <Heat of Combustion>

Heat of combustion (MJ/kg) per mass is defined as an index for determining the flammability of a refrigerant by the American Society of Heating, Refrigeration and Air-conditioning Engineers (ASHRAE) standard 34. In this standard, a substance having a calorific value of 19.000 MJ/kg or more is defined as one of indices of a refrigerant having “strong flammability”.

The heat of combustion is represented by a difference between the sum of the enthalpies of production of the products of the production system in the combustion reaction equation and the enthalpies of production of the compounds of the reaction system.

The enthalpy of production is described in a chemical handbook, an international standard (refer to Reference Literature A), various handbooks, and the like.

In addition, the enthalpy of production for the novel compound can be determined by Benson's group additivity rule (refer to Reference Literature B) or a computational chemical method.

Further, the concept of the combustion reaction equation of a compound containing a halogen is defined in the international standard (refer to Reference Literatures A and C).

Reference Literature A: ANSI/ASHRAE Standard 34 (2016), Designation and Safety Classification of Refrigerants.

Reference Literature B: S. Benson, Thermo chemical kinetics. 2nd Ed. Wiley Interscience. New York (1976).

Reference Literature C: ISO 817 (2014), Refrigerant: Designation and Safety Classification.

In this standard, the heat of combustion is positive for the exothermic reaction.

In the disclosure, the heat of combustion of the working medium is a theoretical value calculated under the following assumption, where the value of the heat of combustion obtained by stoichiometrically completely combusting one mole of the working medium with oxygen is converted into a value of the heat of combustion per 1 kg of the working medium.

It is assumed that the compounds in the production system and the reaction system are gases.

The combustion products are HF (g), CO₂ (g), COF₂ (g), and H₂O (g). In addition, when chlorine, nitrogen, or iodine is a part of the molecular structure of the substance, Cl₂ (g), N₂ (g), or I₂ (g) is added as a combustion product.

When the heat of combustion of the working medium is obtained, each compound contained in the working medium is decomposed into atoms constituting each compound, and a virtual substance containing each atom is set in consideration of the molar ratio in the working medium. The heat of combustion is calculated using the combustion reaction equation of the virtual substance. Note that C_{q}HᵣFₛ in the following formula corresponds to a virtual substance.

For example, the combustion reaction equation is defined by the magnitude of the number of H atoms (r) and the number of F atoms (s) in the substance, and the following equation is used as the combustion reaction equation when the number of H atoms (r)≥the number of F atoms (s).

$${C}_{q} {H}_{r} {F}_{s} + ( q + \frac{r - s}{4} ) {O}_{2} = s HF + {q CO}_{2} + \frac{r - s}{2} {H}_{2} O ( r \geq s ) \qquad [ Math . 1 ]$$

Meanwhile, as the combustion reaction equation in the case the number of H atoms (r)<the number of F atoms (s), the following equation is used.

$${C}_{q} {H}_{r} {F}_{s} + ( q + \frac{s - r}{4} ) {O}_{2} = r HF + \frac{s - r}{2} {COF}_{2} + ( q + \frac{s - r}{2} ) {CO}_{2} ( r < s ) \qquad [ Math . 2 ]$$

### [Composition for Thermal Cycle System]

The composition for a thermal cycle system of the disclosure preferably contains the working medium of the disclosure and a refrigerating machine oil.

### (Refrigerating Machine Oil)

As the refrigerating machine oil, conventionally known refrigerating machine oil used in the composition for a thermal cycle system can be used.

In the thermal cycle device, the refrigerating machine oil preferably has sufficient compatibility with the working medium under low temperature conditions while securing lubricity and sealability of the compressor. From such a viewpoint, the kinematic viscosity of the refrigerating machine oil at 40° C., is preferably 700 mm²/s or less, more preferably 400 mm²/s or less, and still more preferably 300 mm²/s or less. In addition, the kinematic viscosity at 100° C., is preferably 100 mm²/s or less, more preferably 70 mm²/s or less, and still more preferably 50 mm²/s or less.

In the disclosure, the kinematic viscosity is measured by a method specified in JIS K2283:2000.

Specific examples of the refrigerating machine oil include oxygen-containing synthetic oils (such as ester-based refrigerating machine oils and ether-based refrigerating machine oils), fluorine-based refrigerating machine oils, mineral-based refrigerating machine oils, silicone oils, and hydrocarbon-based synthetic oils.

Examples of ester-based refrigerating machine oils include dibasic acid ester oils, polyol ester oils, complex ester oils, and polyol carbonate ester oils.

As dibasic acid ester oils, esters of dibasic acids having from 5 to 10 carbon atoms (such as glutaric acid, adipic acid, pimelic acid, suberic acid, azelaic acid, and sebacic acid) and monohydric alcohols having 1 to 15 carbon atoms with a linear or branched alkyl group (such as methanol, ethanol, propanol, butanol, pentanol, hexanol, heptanol, octanol, nonanol, decanol, undecanol, dodecanol, tridecanol, tetradecanol, and pentadecanol) are preferred. Diacid ester oils are preferably ditridecyl glutarate, di(2-ethylhexyl) adipate, diisodecyl adipate, ditridecyl adipate, or di(3-ethylhexyl) sebacate.

As polyol ester oils, esters of diols (such as ethylene glycol, 1,3-propanediol, propylene glycol, 1,4-butanediol, 1,2-butanediol, 1,5-pentanediol, neopentyl glycol, 1,7-heptanediol, and 1,12-dodecanediol) or polyols having from 3 to 20 hydroxyl groups (such as trimethylolethane, trimethylolpropane, trimethylolbutane, pentaerythritol, glycerin, sorbitol, sorbitan, and sorbitol-glycerin condensates) and fatty acids having from 6 to 20 carbon atoms (such as linear or branched fatty acids like hexanoic acid, heptanoic acid, octanoic acid, nonanoic acid, decanoic acid, undecanoic acid, dodecanoic acid, eicosanoic acid, oleic acid, or so-called neo acids having a quaternary α-carbon atom) are preferred. These polyol ester oils may have a free hydroxyl group.

Polyol ester oils are preferably esters of hindered alcohols (such as neopentyl glycol, trimethylolethane, trimethylolpropane, trimethylolbutane, and pentaerythritol), and more preferably trimethylolpropane tripelargonate, pentaerythritol 2-ethylhexanoate, or pentaerythritol tetrapelargonate.

The complex ester oil is an ester of a fatty acid and a dibasic acid, a monohydric alcohol, and a polyol. As the fatty acid, dibasic acid, monohydric alcohol, and polyol, those similar to those described above can be used.

The polyol carbonate ester oil is an ester of carbonic acid and a polyol. Examples of the polyol include diols similar to those described above and polyols similar to those described above. In addition, the polyol carbonate ester oil may be a ring-opening polymer of a cyclic alkylene carbonate.

Examples of the ether-based refrigerating machine oil include polyvinyl ether oil and polyoxyalkylene oil.

Examples of the polyvinyl ether oil include a polymer obtained by polymerizing a vinyl ether monomer such as an alkyl vinyl ether, and a copolymer obtained by copolymerizing a vinyl ether monomer and a hydrocarbon monomer having an olefinic double bond.

The vinyl ether monomer may be only one kind or two or more kinds.

Examples of the hydrocarbon monomer having an olefinic double bond include ethylene, propylene, various butenes, various pentenes, various hexenes, various heptenes, various octenes, diisobutylene, triisobutylene, styrene, α-methylstyrene, and various alkyl-substituted styrenes. The hydrocarbon monomer having an olefinic double bond may be only one kind or two or more kinds.

The polyvinyl ether oil may be either a block copolymer or a random copolymer.

Examples of polyoxyalkylene oils include polyoxyalkylene mono-ols: polyoxyalkylene polyols; alkyl ether derivatives of polyoxyalkylene mono-ols or polvoxvalkylene polyols; and ester derivatives of polyoxvalkylene mono-ols or polyoxyalkylene polyols.

As polyoxyalkylene oils, alkyl ether derivatives or ester derivatives of polyoxvalkylene mono-ols or polyoxyalkylene polyols are preferred. In addition, the polyoxvalkylene oil is preferably a polyalkylene glycol oil. In particular, as polyoxvalkylene oils, alkyl ether derivatives of polyalkylene glycols, known as polyglycol oils, in which the terminal hydroxyl groups of the polyalkylene glycol are capped with alkyl groups such as methyl groups, are preferred.

Polyoxyalkylene mono-ols and polyoxyalkylene polyols can be produced, for example, by a method in which an alkylene oxide having from 2 to 4 carbon atoms (such as ethylene oxide or propylene oxide) is subjected to ring-opening addition polymerization to a starter such as water or a hydroxyl group-containing compound in the presence of a catalyst such as an alkali hydroxide. In addition, the oxyalkylene units in the polyalkylene chain may be the same in one molecule, or two or more kinds of oxyalkylene units may be contained. It is preferable that at least an oxypropylene unit is contained in one molecule.

Examples of starters used in the reaction include water; monohydric alcohols such as methanol and butanol; and polyhydric alcohols such as ethylene glycol, propylene glycol, pentaerythritol, and glycerol.

Examples of fluorine-based refrigerating machine oils include compounds in which the hydrogen atoms of synthetic oils (such as mineral oils, poly-α-olefins, alkylbenzenes, and alkylnaphthalenes, which will be described later) are substituted with fluorine atoms, fluorinated oils, perfluoropolyether oils, and fluorinated silicone oils.

Examples of mineral-based refrigerating machine oils include mineral oils obtained by subjecting refrigerating machine oil fractions, which are obtained by atmospheric distillation or vacuum distillation of crude oil, to purification treatments (such as solvent deasphalting, solvent extraction, hydrocracking, solvent dewaxing, catalytic dewaxing, hydrotreating, and clay treatment) in appropriate combinations. Such mineral oils include, for example, paraffinic mineral oils and naphthenic mineral oils.

Examples of hydrocarbon-based synthetic oils include poly-α-olefins, alkylbenzenes, and alkylnaphthalenes.

The refrigerating machine oil contained in the composition for a thermal cycle system may be only one kind or two or more kinds.

In particular, the refrigerating machine oil is preferably at least one selected from the group consisting of polyalkylene glycol oil, polyol ester oil, polyvinyl ether oil, silicone oil, fluorine-containing oil, mineral oil, and hydrocarbon-based synthetic oil, and more preferably at least one selected from the group consisting of polyalkylene glycol oil, polyol ester oil, polyvinyl ether oil, and mineral oil.

The refrigerating machine oil may further contain at least one selected from the group consisting of an antioxidant, an extreme pressure agent, an acid scavenger, an oxygen scavenger, a copper deactivator, a rust inhibitor, an oil agent, and an antifoaming agent.

The content of the refrigerating machine oil in the composition for a thermal cycle system may be within a range that does not significantly deteriorate the effect of the disclosure, and is preferably in a range of from 10 parts by mass to 100 parts by mass, and more preferably in a range of from 20 parts by mass to 50 parts by mass relative to 100 parts by mass of the working medium.

### (Additive)

The composition for a thermal cycle system may contain at least one known additive selected from the group consisting of a tracer, a stabilizer, a polymerization inhibitor, and a leakage detection substance in addition to the working medium and the refrigerating machine oil.

The tracer is preferably added at a detectable concentration in the working medium of the disclosure such that any dilution, contamination, or other change can be traced.

The tracer included in the working medium of the disclosure may be only one kind or two or more kinds.

The tracer is not particularly limited, and can be appropriately selected from commonly used tracers. It is preferable to select, as the tracer, a compound that cannot become an impurity unavoidably mixed into the working medium of the disclosure.

Preferred tracers include the following compounds.
HC-40 (chloromethane, CH₃Cl)
HFC-161 (fluoroethane, CH₃CH₂F)
HFC-245fa (1,1,1,3,3-pentafluoropropane, CF₃CH₂CHF₂)
HFC-236fa (1,1,1,3,3,3-hexafluoropropane, CF₃CH₂CF₃)
HFC-236ea (1,1,1,2,3,3-hexafluoropropane, CF₃CHFCHF₂)
HCFC-22 (chlorodifluoromethane. CHClF₂)
HCFC-31 (chlorofluoromethane, CH₂ClF)
CFC-1113 (chlorotrifluoroethylene, CF₂═CClF)
HFE-125 (trifluoromethyl-difluoromethyl ether, CF₃OCHF₂)
HFE-134a (trifluoromethyl-fluoromethyl ether. CF₃OCH₂F), HFE-143a (trifluoromethyl-methyl ether, CF₃OCH₃)
HFE-227ea (trifluoromethyl-tetrafluoroethyl ether. CF₃OCHFCF₃)
HFE-236fa (trifluoromethyl-trifluoroethyl ether, CF₃OCH₂CF₃)

The content of the tracer is preferably in a range of from 10 to 1,000 ppm by mass, more preferably in a range of from 30 to 500 ppm by mass, still more preferably in a range of from 50 to 300 ppm by mass, particularly preferably in a range of from 75 to 250 ppm by mass, and most preferably in a range of from 100 to 200 ppm by mass relative to the total amount of the working medium.

The stabilizer is a component that improves the stability of the working medium against heat and oxidation. Examples of the stabilizer include conventionally known stabilizers such as an oxidation resistance improver, a heat resistance improver, and a metal deactivator.

Examples of oxidation resistance improvers and heat resistance improvers include N,N′-diphenylphenylenediamine, p-octyldiphenylamine, p,p′-dioctyldiphenylamine, N-phenyl-1-naphthylamine, N-phenyl-2-naphthylamine, N-(p-dodecyl)phenyl-2-naphthylamine, di-1-naphthylamine, di-2-naphthylamine, N-alkylphenothiazine, 6-(tert-butyl) phenol, 2,6-di(tert-butyl) phenol, 4-methyl-2,6-di(tert-butyl) phenol, and 4,4-methylenebis(2,6-di-tert-butylphenol). Each of the oxidation resistance improver and the heat resistance improver may be one kind or two or more kinds.

Examples of metal deactivators include imidazole, benzimidazole, 2-mercaptobenzothiazole, 2,5-dimethylmercaptothiadiazole, salicylidene-propylenediamine, pyrazole, benzotriazole, tolyltriazole. 2-methylbenzimidazole, 3,5-dimethylpyrazole, methylenebis-benzotriazole, organic acids or their esters, primary, secondary, or tertiary aliphatic amines, amine salts of organic or inorganic acids, nitrogen-containing heterocyclic compounds, amine salts of alkyl phosphates, or derivatives thereof.

The content of the stabilizer may be within a range that does not significantly deteriorate the effect of the disclosure, and is usually in a range of from 0.01 to 5% by mass, preferably in a range of from 0.05 to 3% by mass, more preferably in a range of from 0.1 to 2% by mass, still more preferably in a range of from 0.25 to 1.5% by mass, and particularly preferably in a range of from 0.5 to 1% by mass relative to 100 parts by mass of the working medium.

The polymerization inhibitor is not particularly limited, and can be appropriately selected from commonly used polymerization inhibitors. The polymerization inhibitor contained in the working medium of the disclosure may be only one kind or two or more kinds.

Examples of polymerization inhibitors include 4-methoxy-1-naphthol, hydroquinone, hydroquinone methyl ether, dimethyl-tert-butylphenol, 2,6-di-tert-butyl-p-cresol, and benzotriazole.

The content of the polymerization inhibitor is not particularly limited, and is usually in a range of from 0.01 to 5% by mass, preferably in a range of from 0.05 to 3% by mass, more preferably in a range of from 0.1 to 2% by mass, still more preferably in a range of from 0.25 to 1.5% by mass, and particularly preferably in a range of from 0.5 to 1% by mass relative to the total amount of the working medium.

Examples of the leakage detection substance include an ultraviolet fluorescent dye, an odor gas, and an odor masking agent.

Examples of the ultraviolet fluorescent dye include conventionally known ultraviolet fluorescent dyes such as those described in U.S. Pat. No. 4,249,412, Japanese National-Phase Publication (JP-A) No. H10-502737. Japanese National-Phase Publication (JP-A) No. 2007-511645, Japanese National-Phase Publication (JP-A) No. 2008-500437, and Japanese National-Phase Publication (JP-A) No. 2008-531836.

Examples of the odor masking agent include conventionally known perfumes such as those described in JP-A Nos. 2008-500437 and 2008-531836.

When the leakage detection substance is used, a solubilizing agent that improves the solubility of the leakage detection substance in the working medium may be used.

Examples of the solubilizing agent include those described in JP-A Nos. 2007-511645, 2008-500437, and 2008-531836.

The content of the leakage detection substance may be within a range that does not significantly deteriorate the effect of the disclosure, and is preferably 2 parts by mass or less, and more preferably 0.5 parts by mass or less relative to 100 parts by mass of the working medium.

The working medium of the disclosure is used in a thermal cycle device. The thermal cycle device may be a heat pump system that utilizes the thermal energy obtained in the condenser, or a refrigeration cycle system that utilizes the cold energy obtained in the evaporator.

Specific examples of the heat cycle device include chilling and freezing equipment, air-conditioning equipment, heating and hot water equipment, an electric power generation systems, a heat transport apparatus, and a secondary cooling machine. In particular, the heat cycle system can stably and safely exert heat cycle performance even in a higher-temperature working environment, and therefore is preferably used as air-conditioning equipment often installed outdoors. The heat cycle system is also preferably used as chilling and freezing equipment.

Specific examples of the air conditioner include a room air conditioner, a packaged air conditioner (such as a packaged air conditioner for stores, a packaged air conditioner for buildings, and a packaged air conditioner for facilities), a gas engine heat pump, a train air conditioner, and an air conditioner for a vehicle.

The air-conditioning apparatus for automobiles is preferably air-conditioning equipment for gasoline vehicles, air-conditioning equipment for hybrid automobiles, air-conditioning equipment for electric automobiles, or air-conditioning equipment for hydrogen automobiles, more preferably air-conditioning equipment for electric automobiles.

Specific examples of the chilling and freezing equipment include a refrigerated display (a refrigeration showcase, a freezing showcase, or the like), a refrigerator, a freezer, a water cooling equipment, a chilling and freezing unit, a freezing machine for water chilling equipment warehouses, a chiller (chilling unit), a turbo freezing machine, a screw freezing machine, an automatic vending machine, and an ice-making machine.

Specific examples of the heating and hot water equipment include a heat pump hot water machine, a heat pump warm water heater, a heat pump warm air heater, a vapor/hot air generation heat pump, and an exhaust heat recovery heat pump.

The electric power generation systems is preferably an electric power generation systems with a Rankine cycle system. Specific examples of the electric power generation systems include a system in which the working medium is heated by, for example, geothermal energy, solar heat, or waste heat in a medium to high temperature range of from about 50° C., to 200° C., in the evaporator, the working medium formed into vapor in a high-temperature and high-pressure state is adiabatically expanded in an expansion machine, and the work generated by such adiabatic expansion is allowed to drive an electric power generation systems machine, to perform electric power generation.

The heat transport apparatus is preferably a latent heat transport apparatus. Examples of the latent heat transport apparatus include a heat pipe and a two-phase closed-type thermosyphon apparatus, in which latent heat transport is performed by use of a phenomenon of evaporation, boiling, condensation, and the like of the working medium enclosed in the apparatus. The heat pipe is applied to a relatively small cooling apparatus such as a cooling apparatus of a heat generation portion of a semiconductor device or electronic equipment. The two-phase closed-type thermosyphon apparatus does not require any wig and is simple in terms of structure, and therefore is widely utilized for a gas-gas type heat exchanger, promotion of snow melting, freeze proofing, and the like on the load, and the like.

### [Thermal Cycle Device and Thermal Cycle Method]

A thermal cycle device of the disclosure includes:
the working medium (particularly, the first working medium) of the disclosure;
a compressor that compresses vapor of the working medium;
a condenser that cools and liquefies the vapor of the working medium discharged from the compressor;
a pressure-reducing device that reduces the pressure of the working medium discharged from the condenser; and
an evaporator that heats the working medium discharged from the pressure-reducing device.

The working medium applied to the thermal cycle device may be used as a composition for thermal cycles.

A thermal cycle method of the disclosure is a method that compresses vapor of the working medium (particularly, the first working medium) of the disclosure, cools and liquefies the vapor of the working medium discharged from the compressor, reduces the pressure of the liquefied working medium, and heats the pressure-reduced working medium.

The thermal cycle device to which the working medium of the disclosure is applied may be a heat pump device that utilizes the thermal energy obtained in the condenser, or a refrigeration cycle device that utilizes the cold energy obtained in the evaporator. The thermal cycle device of the disclosure may be a direct expansion type or an indirect expansion type. Examples of the indirect expansion type include a flooded evaporator type.

The thermal cycle includes a series of cycles in which (1) the working medium is compressed by a compressor in a gaseous state, (2) the working medium is cooled by a condenser to be changed to a liquid state with a high pressure, (3) the pressure is lowered by an expansion valve which is an example of a pressure-reducing device, and (4) the working medium is vaporized at a low temperature in an evaporator to absorb heat by heat of vaporization. Compressors can be classified by the method of compressing the working medium in a gaseous state into types such as turbo (centrifugal), reciprocating, rotary, twin screw, single screw, and scroll compressors, and can be selected based on thermal capacity, compression ratio, and size.

An example of the refrigeration cycle system to which the thermal cycle device of the disclosure is applied is as described above.

The working medium of the disclosure is used in a refrigeration cycle device in which an evaporation temperature is controlled to be in a range of from −45 to 10° C., for example.

The evaporator is preferably operated at an evaporation temperature of the working medium of from −45 to 10° C. The evaporation temperature of the working medium at the evaporator may be automatically controlled.

Further, in the thermal cycle method to which the working medium is applied, it is preferable to heat the pressure-reduced working medium at an evaporation temperature of −45 to 10° C.

When the evaporation temperature is 10° C. or lower, the discharge temperature can be lower than the discharge temperature of the HFC-134a, and the reliability as a refrigeration cycle is improved. Meanwhile, when the evaporation temperature is −45° C. or higher, the evaporation pressure is 0.0300 MPa or higher, and the load on suction of the refrigerant into the compressor is reduced.

From the above viewpoint, the evaporation temperature is more preferably 7° C. or lower, and still more preferably 5° C. or lower. In addition, the evaporation temperature is more preferably −30° C. or higher, and still more preferably −20° C. or higher.

In particular, the evaporation temperature of the working medium is more preferably controlled to be in a range of from −30 to 10° C., and even more preferably to be in a range of from −20 to 10° C.

In the disclosure, the evaporation temperature means a temperature at which the working medium absorbs heat and turns into steam in the evaporation step of the thermal cycle device.

In the disclosure, the condensation temperature means a temperature at which the vapor of the working medium releases heat and turns into a liquid in the condensation step of the thermal cycle device.

The evaporation temperature can be determined by measuring the temperature of at least one of the evaporator inlet and the evaporator outlet. In the case of a single medium or an azeotropic mixed medium, the evaporation temperature is constant, but, in the case of a non-azeotropic mixed medium, the evaporation temperature becomes the average temperature of the evaporation start temperature and the evaporation completion temperature, and is calculated as “evaporation temperature=(evaporation start temperature+evaporation completion temperature)/2”.

In addition, the condensation temperature can be determined by measuring the temperature of at least one of the condenser inlet and the condenser outlet. In the case of a single medium or an azeotropic mixed medium, the condensation temperature is constant, but, in the case of a non-azeotropic mixed medium, the condensation temperature becomes the average temperature of the condensation start temperature and the condensation completion temperature, and is calculated as “condensation temperature=(condensation start temperature+condensation completion temperature)/2”.

The condenser is preferably operated at a condensation temperature of the working medium of from 30 to 80° C. The condensation temperature of the working medium at the condenser may be automatically controlled.

Further, in the thermal cycle method using the working medium, it is preferable that the vapor of the working medium is cooled in a range of from 30 to 80° C., to be liquefied.

When the condensation temperature is 30° C. or higher, the discharge temperature can be lower than the discharge temperature of the HFC-134a, and the reliability as a refrigeration cycle is improved. Meanwhile, when the condensation temperature is 80° C. or lower, the temperature becomes equal to or lower than the critical temperature of the working medium.

Further, in the thermal cycle device using the working medium, from the viewpoint of reducing the load related to suction of the refrigerant into the compressor, the evaporation pressure of the working medium is preferably 0.0300 MPa or more, more preferably 0.0650 MPa or more, and still more preferably 0.1013 MPa or more.

In the thermal cycle device in which the working medium is used, from the viewpoint of improving the reliability of the constituent members in the thermal cycle device, the discharge temperature of the working medium is preferably equal to or lower than the discharge temperature of the HFC-134a, more preferably 9.00% or more, and still more preferably 10.25% or more as a reduction effect based on the discharge temperature of HFC-134a.

The discharge temperature reduction effect of the working medium based on the discharge temperature of HFC-134a (%)={(discharge temperature (° C.) of HFC-134a-discharge temperature (° C.) of working medium)/discharge temperature (° C.) of HFC-134a}×100

At least a part of the surface in contact with the working medium in the component constituting the thermal cycle device may contain at least one selected from the group consisting of copper and copper alloys. The component is preferably at least one selected from the group consisting of a compressor, a condenser, an evaporator, and a refrigerant pipe.

### EXAMPLES

Hereinafter, the disclosure will be described more specifically with reference to examples, but the disclosure is not limited to the following examples unless it goes beyond the gist of the disclosure. Examples 1 to 12 are examples, and Examples 13 to 15 are comparative examples. Examples 101 to 125 are examples, and Examples 126 and 127 are comparative examples.

The working medium containing HFO-1234yf, HCFO-1224yd(Z), and HFC-134a having the composition (% by mass) shown in Table 1 was evaluated.

For the working medium, the temperature difference between the dew point and the boiling point at atmospheric pressure (denoted as “dew point-boiling point difference” in the table), heat of combustion (denoted as “HOC” in the table), evaporation glide, coefficient of performance (denoted as “COP” in the table), capacity per unit volume (denoted as “CAP” in the table), condensation pressure (denoted as “Pc” in the table), evaporation pressure (denoted as “Pe” in the table), and discharge temperature (denoted as “Td” in the table) were measured. Additionally, the discharge temperature difference (denoted as “Td difference” in the table), the discharge temperature reduction effect (denoted as “Td reduction effect” in the table), and the global warming potential (denoted as “GWP” in the table) were calculated.

The methods for evaluating the dew point-boiling point difference, the HOC, the evaporation glide, the COP, the CAP, the Pc, the Pe, and the Td are as described above. The COP, the CAP, the Pc, and the Pe were evaluated in terms of relative values with the value of the HFC-134a as a reference (HFC-134a=1.00). The GWP was based on the 100-year value from the Fifth Assessment Report (AR5) of the Intergovernmental Panel on Climate Change (IPCC). A method of calculating the Td difference and the Td reduction effect is as follows.

$$Td difference ( °C . ) = ( discharge temperature of working medium ( °C . ) ) - ( discharge temperature of HFC - 134 a ( °C . ) )$$

$$Td reduction effect ( \% ) = \{ ( discharge temperature of HFC - 134 a - discharge temperature ( °C . ) of working medium ) / discharge temperature ( °C . ) of HFC - 134 a \} \times 100$$

TABLE 1

| | HFO- | HCFO- | HFC- | Dew point- | | | Eva- | | | | | | | |
|---|---|---|---|---|---|---|---|---|---|---|---|---|---|---|
| | 1234yf | 1224yd(Z) | 134a | boiling point | | | poration | | | | | | Td | Td reduction |
| | (% by | (% by | (% by | difference | HOC | | glide | | | | | Td | difference | effect |
| | mass) | mass) | mass) | (° C.) | (MJ/kg) | GWP | (° C.) | COP | CAP | Pc | Pe | (° C.) | (° C.) | (%) |
| Example 1 | 73.0 | 12.0 | 15.0 | 6.24 | 9.595 | 196 | 4.55 | 0.962 | 0.860 | 0.91 | 0.92 | 60.0 | −6.0 | 9.073 |
| Example 2 | 82.0 | 3.0 | 15.0 | 1.61 | 10.013 | 196 | 1.14 | 0.952 | 0.937 | 0.99 | 1.06 | 57.5 | −8.5 | 12.92 |
| Example 3 | 78.0 | 12.0 | 10.0 | 6.17 | 9.788 | 131 | 4.47 | 0.960 | 0.851 | 0.90 | 0.92 | 59.5 | −6.6 | 9.94 |
| Example 4 | 80.0 | 10.0 | 10.0 | 5.19 | 9.881 | 131 | 3.73 | 0.958 | 0.868 | 0.92 | 0.95 | 58.9 | −7.1 | 10.77 |
| Example 5 | 82.0 | 8.0 | 10.0 | 4.19 | 9.974 | 131 | 2.98 | 0.956 | 0.885 | 0.94 | 0.97 | 58.4 | −7.7 | 11.60 |
| Example 6 | 87.0 | 3.0 | 10.0 | 1.59 | 10.206 | 131 | 1.12 | 0.950 | 0.927 | 0.99 | 1.05 | 57.0 | −9.0 | 13.69 |
| Example 7 | 80.0 | 12.0 | 8.0 | 6.14 | 9.865 | 105 | 4.43 | 0.959 | 0.848 | 0.90 | 0.91 | 59.2 | −6.8 | 10.28 |
| Example 8 | 90.0 | 3.0 | 7.0 | 1.57 | 10.322 | 92 | 1.10 | 0.949 | 0.921 | 0.98 | 1.05 | 56.7 | −9.3 | 14.16 |
| Example 9 | 85.0 | 12.0 | 3.0 | 6.03 | 10.058 | 40 | 4.32 | 0.957 | 0.838 | 0.89 | 0.91 | 58.6 | −7.4 | 11.18 |
| Example 10 | 87.0 | 10.0 | 3.0 | 5.07 | 10.151 | 40 | 3.60 | 0.955 | 0.854 | 0.91 | 0.94 | 58.1 | −7.9 | 11.98 |
| Example 11 | 90.0 | 7.0 | 3.0 | 3.57 | 10.291 | 40 | 2.51 | 0.952 | 0.879 | 0.94 | 0.98 | 57.3 | −8.7 | 13.19 |
| Example 12 | 92.0 | 4.0 | 4.0 | 2.06 | 10.391 | 53 | 1.43 | 0.949 | 0.905 | 0.97 | 1.03 | 56.6 | −9.4 | 14.22 |
| Example 13 | 68.0 | 12.0 | 20.0 | 6.27 | 9.402 | 260.8 | 4.61 | 0.964 | 0.8677 | 0.91 | 0.92 | 60.6 | −5.43 | 8.22 |
| Example 14 | 70.0 | 15.0 | 15.0 | 7.65 | 9.456 | 196 | 5.65 | 0.966 | 0.834 | 0.88 | 0.88 | 60.9 | −5.2 | 7.82 |
| Example 15 | 70.0 | 20.0 | 10.0 | 9.75 | 9.416 | 131 | 7.30 | 0.970 | 0.786 | 0.83 | 0.81 | 61.6 | −4.5 | 6.76 |

As shown in Table 1, in Examples 1 to 12, HFO-1234yf, HCFO-1224yd(Z), and HFC-134a were contained, the content of HFC-134a is 15.0% by mass or less relative to the total content of the HFO-1234yf, the HCFO-1224yd(Z), and the HFC-134a, the content of HCFO-1224yd(Z) is 12.0% by mass or less relative to the total content of the HFO-1234yf, the HCFO-1224yd(Z), and the HFC-134a, and the content of HFO-1234yf is 73.0% by mass or more relative to the total content of the HFO-1234yf, the HCFO-1224yd(Z), and the HFC-134a. As a result, it was found that the temperature difference between the dew point and the boiling point at atmospheric pressure of 6.50° C. or less and a GWP of 200 or less can be achieved.

Meanwhile, in Example 13, it was found that the content of the HFC-134a was more than 15.0% by mass, and the GWP was as high as 261.

In Examples 14 and 15, it was found that the content of HCFO-1224yd(Z) was more than 12.0% by mass, and the temperature difference between the dew point and the boiling point at atmospheric pressure was large.

A working medium containing HFO-1234yf, HFO-1234ze(E), HCFO-1224yd(Z), and HFC-134a was prepared to have the composition (% by mass) shown in Table 2.

For the working medium, the temperature difference between the dew point and the boiling point at atmospheric pressure, the heat of combustion, the evaporation glide, the COP, the CAP, the condensation pressure, the evaporation pressure, and the discharge temperature were measured. In addition, the difference in discharge temperature, the discharge temperature reduction effect, and the GWP were calculated. The evaluation method and the calculation method are similar to those in Example 1.

TABLE 2

| | HFO- | HFO- | HCFO- | HFC- | Dew point- | | | Eva- | | | | | | | Td |
|---|---|---|---|---|---|---|---|---|---|---|---|---|---|---|---|
| | 1234yf | 1234ze | 1224yd | 134a | boiling point | HOC | | poration | | | | | | Td | reduction |
| | (% by | (E) (% | (Z) (% | (% by | difference | (MJ/ | | glide | | | | | Td | difference | effect |
| | mass) | by mass) | by mass) | mass) | (° C.) | kg) | GWP | (° C.) | COP | CAP | Pc | Pe | (° C.) | (° C.) | (%) |
| Example 101 | 38.0 | 35.0 | 12.0 | 15.0 | 6.20 | 9.388 | 196 | 4.51 | 0.978 | 0.807 | 0.84 | 0.83 | 61.2 | −4.9 | 7.377 |
| Example 102 | 48.0 | 25.0 | 12.0 | 15.0 | 6.30 | 9.448 | 196 | 4.60 | 0.973 | 0.825 | 0.86 | 0.86 | 60.9 | −5.2 | 7.82 |
| Example 103 | 58.0 | 15.0 | 12.0 | 15.0 | 6.32 | 9.507 | 196 | 4.62 | 0.968 | 0.841 | 0.88 | 0.88 | 60.5 | −5.5 | 8.30 |
| Example 104 | 63.0 | 10.0 | 12.0 | 15.0 | 6.30 | 9.536 | 196 | 4.60 | 0.966 | 0.848 | 0.89 | 0.90 | 60.4 | −5.7 | 8.56 |
| Example 105 | 68.0 | 5.0 | 12.0 | 15.0 | 6.27 | 9.566 | 196 | 4.58 | 0.964 | 0.854 | 0.90 | 0.91 | 60.2 | −5.8 | 8.82 |
| Example 106 | 43.0 | 35.0 | 12.0 | 10.0 | 6.23 | 9.581 | 131 | 4.50 | 0.975 | 0.803 | 0.84 | 0.83 | 60.6 | −5.4 | 8.22 |
| Example 107 | 53.0 | 25.0 | 12.0 | 10.0 | 6.29 | 9.640 | 131 | 4.57 | 0.970 | 0.820 | 0.86 | 0.86 | 60.3 | −5.7 | 8.68 |
| Example 108 | 63.0 | 15.0 | 12.0 | 10.0 | 6.28 | 9.700 | 131 | 4.56 | 0.966 | 0.834 | 0.88 | 0.88 | 60.0 | −6.1 | 9.16 |
| Example 109 | 68.0 | 10.0 | 12.0 | 10.0 | 6.25 | 9.729 | 131 | 4.54 | 0.963 | 0.840 | 0.89 | 0.90 | 59.8 | −6.2 | 9.42 |
| Example 110 | 73.0 | 5.0 | 12.0 | 10.0 | 6.22 | 9.759 | 131 | 4.51 | 0.962 | 0.846 | 0.89 | 0.91 | 59.6 | −6.4 | 9.68 |
| Example 111 | 45.0 | 35.0 | 10.0 | 10.0 | 5.42 | 9.674 | 131 | 3.87 | 0.973 | 0.820 | 0.86 | 0.85 | 60.1 | −5.9 | 8.97 |
| Example 112 | 55.0 | 25.0 | 10.0 | 10.0 | 5.42 | 9.733 | 131 | 3.89 | 0.968 | 0.836 | 0.88 | 0.88 | 59.8 | −6.2 | 9.47 |
| Example 113 | 65.0 | 15.0 | 10.0 | 10.0 | 5.35 | 9.792 | 131 | 3.85 | 0.963 | 0.851 | 0.90 | 0.91 | 59.4 | −6.6 | 9.98 |
| Example 114 | 70.0 | 10.0 | 10.0 | 10.0 | 5.30 | 9.822 | 131 | 3.81 | 0.961 | 0.857 | 0.91 | 0.92 | 59.3 | −6.8 | 10.25 |
| Example 115 | 75.0 | 5.0 | 10.0 | 10.0 | 5.25 | 9.852 | 131 | 3.77 | 0.959 | 0.863 | 0.91 | 0.93 | 59.1 | −6.9 | 10.51 |
| Example 116 | 47.0 | 35.0 | 8.0 | 10.0 | 4.58 | 9.767 | 131 | 3.22 | 0.970 | 0.837 | 0.88 | 0.88 | 59.6 | −6.4 | 9.72 |
| Example 117 | 57.0 | 25.0 | 8.0 | 10.0 | 4.51 | 9.826 | 131 | 3.19 | 0.965 | 0.854 | 0.90 | 0.91 | 59.2 | −6.8 | 10.27 |
| Example 118 | 67.0 | 15.0 | 8.0 | 10.0 | 4.39 | 9.885 | 131 | 3.12 | 0.961 | 0.868 | 0.92 | 0.94 | 58.9 | −7.1 | 10.81 |
| Example 119 | 72.0 | 10.0 | 8.0 | 10.0 | 4.32 | 9.915 | 131 | 3.07 | 0.959 | 0.874 | 0.93 | 0.95 | 58.7 | −7.3 | 11.09 |
| Example 120 | 77.0 | 5.0 | 8.0 | 10.0 | 4.25 | 9.944 | 131 | 3.03 | 0.957 | 0.880 | 0.93 | 0.96 | 58.5 | −7.5 | 11.35 |
| Example 121 | 48.0 | 35.0 | 7.0 | 10.0 | 4.14 | 9.814 | 131 | 2.89 | 0.969 | 0.846 | 0.89 | 0.90 | 59.3 | −6.7 | 10.12 |
| Example 122 | 58.0 | 25.0 | 7.0 | 10.0 | 4.04 | 9.873 | 131 | 2.83 | 0.964 | 0.863 | 0.91 | 0.93 | 59.0 | −7.1 | 10.68 |
| Example 123 | 68.0 | 15.0 | 7.0 | 10.0 | 3.89 | 9.932 | 131 | 2.75 | 0.960 | 0.877 | 0.93 | 0.95 | 58.6 | −7.4 | 11.24 |
| Example 124 | 73.0 | 10.0 | 7.0 | 10.0 | 3.82 | 9.961 | 131 | 2.70 | 0.958 | 0.883 | 0.93 | 0.97 | 58.4 | −7.6 | 11.51 |
| Example 125 | 78.0 | 5.0 | 7.0 | 10.0 | 3.74 | 9.991 | 131 | 2.65 | 0.956 | 0.889 | 0.94 | 0.98 | 58.3 | −7.8 | 11.77 |
| Example 126 | 35.0 | 35.0 | 15.0 | 15.0 | 7.32 | 9.249 | 196 | 5.39 | 0.982 | 0.782 | 0.81 | 0.79 | 61.9 | −4.2 | 6.32 |
| Example 127 | 40.0 | 35.0 | 15.0 | 10.0 | 7.37 | 9.442 | 131 | 5.40 | 0.979 | 0.777 | 0.81 | 0.79 | 61.3 | −4.7 | 7.16 |

As shown in Table 2, in Examples 101 to 125, HFO-1234yf, HFO-1234ze(E), HCFO-1224yd(Z), and HFC-134a were contained, the content of HFC-134a is15.0% by mass or less relative to the total content of the HFO-1234yf, the HFO-1234ze(E), the HCFO-1224yd(Z), and the HFC-134a, the content of HFO-1234ze(E) is 35.0% by mass or less relative to the total content of the HFO-1234yf, the HFO-1234ze(E), the HCFO-1224yd(Z), and the HFC-134a, the content of HCFO-1224yd(Z) is 12.0% by mass or less relative to the total content of the HFO-1234yf, the HFO-1234ze(E), the HCFO-1224yd(Z), and the HFC-134a, and the content of HFO-1234yf is 38.0% by mass or more with respect to the total content of the HFO-1234vf, the HFO-1234ze(E), the HCFO-1224yd(Z), and the HFC-134a. As a result, it was found that the temperature difference between the dew point and the boiling point at atmospheric pressure of 6.50° C. or less and a GWP of 200 or less can be achieved.

Meanwhile, in Examples 126 and 127, it was found that the content of HCFO-1224yd(Z) was more than 12.0% by mass, and the temperature difference between the dew point and the boiling point at atmospheric pressure was large.

Next, the saturated vapor pressure at the temperature (Te′) was calculated for the working medium of Examples 1 to 15.

When the working medium is a single substance or an azeotropic mixture, the saturated liquid pressure at the boiling point temperature and the saturated vapor pressure at the dew point temperature at the same temperature are substantially the same.

Meanwhile, when the working medium is a non-azeotropic mixture, the saturated liquid pressure and the saturated vapor pressure at the same temperature are different, and the saturated vapor pressure has a smaller value than the saturated liquid pressure.

Therefore, since the evaporation pressure is calculated as the evaporation temperature=(evaporation start temperature+evaporation completion temperature)/2 with the evaporation temperature as an average temperature of the evaporation start temperature and the evaporation completion temperature, the minimum evaporation pressure can be determined by the saturated vapor pressure at the temperature (Te′) that is set and controlled as the evaporation temperature.

TABLE 3

| | HFO- | HCFO- | HFC- | | | | | | |
|---|---|---|---|---|---|---|---|---|---|
| | 1234yf | 1224yd | 134a | | | | | | |
| | (% by | (Z) (% | (% by | Te′ = | Te′ = | Te′ = | Te′ = | Te′ = | Te′ = |
| | mass) | by mass) | mass) | 10° C. | 5° C. | 0° C. | −5° C. | −10° C. | −15° C. |
| Example 1 | 73.0 | 12.0 | 15.0 | 0.3536 | 0.2973 | 0.2481 | 0.2053 | 0.1684 | 0.1369 |
| Example 2 | 82.0 | 3.0 | 15.0 | 0.4232 | 0.3593 | 0.3030 | 0.2536 | 0.2107 | 0.1736 |
| Example 3 | 78.0 | 12.0 | 10.0 | 0.3523 | 0.2963 | 0.2474 | 0.2048 | 0.1681 | 0.1367 |
| Example 4 | 80.0 | 10.0 | 10.0 | 0.3668 | 0.3092 | 0.2588 | 0.2148 | 0.1768 | 0.1442 |
| Example 5 | 82.0 | 8.0 | 10.0 | 0.3818 | 0.3225 | 0.2705 | 0.2251 | 0.1858 | 0.1520 |
| Example 6 | 87.0 | 3.0 | 10.0 | 0.4207 | 0.3573 | 0.3014 | 0.2525 | 0.2098 | 0.1730 |
| Example 7 | 80.0 | 12.0 | 8.0 | 0.3517 | 0.2959 | 0.2471 | 0.2046 | 0.1680 | 0.1366 |
| Example 8 | 90.0 | 3.0 | 7.0 | 0.4190 | 0.3560 | 0.3004 | 0.2516 | 0.2092 | 0.1725 |
| Example 9 | 85.0 | 12.0 | 3.0 | 0.3499 | 0.2945 | 0.2460 | 0.2039 | 0.1675 | 0.1362 |
| Example 10 | 87.0 | 10.0 | 3.0 | 0.3641 | 0.3071 | 0.2572 | 0.2136 | 0.1759 | 0.1436 |
| Example 11 | 90.0 | 7.0 | 3.0 | 0.3861 | 0.3267 | 0.2745 | 0.2289 | 0.1893 | 0.1552 |
| Example 12 | 92.0 | 4.0 | 4.0 | 0.4095 | 0.3475 | 0.2930 | 0.2452 | 0.2036 | 0.1677 |
| Example 13 | 68.0 | 12.0 | 20.0 | 0.3545 | 0.2980 | 0.2485 | 0.2056 | 0.1686 | 0.1369 |
| Example 14 | 70.0 | 15.0 | 15.0 | 0.3324 | 0.2786 | 0.2317 | 0.1911 | 0.1561 | 0.1263 |
| Example 15 | 70.0 | 20.0 | 10.0 | 0.2990 | 0.2495 | 0.2065 | 0.1694 | 0.1377 | 0.1107 |
| | | Te′ = | Te′ = | Te′ = | Te′ = | Te′ = | Te′ = | Te′ = | |
| | | −20° C. | −25° C. | −30° C. | −35° C. | −40° C. | −45° C. | −50° C. | |
| | Example 1 | 0.1101 | 0.0875 | 0.0688 | 0.0533 | 0.0408 | 0.0307 | 0.0227 | |
| | Example 2 | 0.1417 | 0.1146 | 0.0917 | 0.0726 | 0.0568 | 0.0438 | 0.0333 | |
| | Example 3 | 0.1100 | 0.0875 | 0.0688 | 0.0534 | 0.0408 | 0.0307 | 0.0227 | |
| | Example 4 | 0.1164 | 0.0929 | 0.0734 | 0.0572 | 0.0439 | 0.0332 | 0.0247 | |
| | Example 5 | 0.1231 | 0.0987 | 0.0782 | 0.0612 | 0.0473 | 0.0360 | 0.0270 | |
| | Example 6 | 0.1413 | 0.1143 | 0.0915 | 0.0725 | 0.0567 | 0.0438 | 0.0334 | |
| | Example 7 | 0.1099 | 0.0875 | 0.0688 | 0.0534 | 0.0408 | 0.0308 | 0.0228 | |
| | Example 8 | 0.1409 | 0.1141 | 0.0914 | 0.0724 | 0.0567 | 0.0438 | 0.0334 | |
| | Example 9 | 0.1097 | 0.0874 | 0.0687 | 0.0534 | 0.0409 | 0.0308 | 0.0228 | |
| | Example 10 | 0.1160 | 0.0927 | 0.0732 | 0.0571 | 0.439 | 0.0333 | 0.0248 | |
| | Example 11 | 0.1260 | 0.1013 | 0.0805 | 0.0632 | 0.0490 | 0.0375 | 0.0282 | |
| | Example 12 | 0.1368 | 0.1106 | 0.0884 | 0.0699 | 0.0546 | 0.0421 | 0.0320 | |
| | Example 13 | 0.1100 | 0.0875 | 0.0687 | 0.0532 | 0.0406 | 0.0306 | 0.0226 | |
| | Example 14 | 0.1011 | 0.0800 | 0.0625 | 0.0482 | 0.0366 | 0.0274 | 0.0201 | |
| | Example 15 | 0.0881 | 0.0692 | 0.0537 | 0.0411 | 0.0310 | 0.0229 | 0.0167 | |

As shown in Table 3, in Example 1 to 13, when the evaporation temperature was in a range of from −45 to 10° C., the saturated vapor pressure estimated as the evaporation pressure was 0.0300 MPa or more, when the evaporation temperature was in a range of from −30 to 10° C., the saturated vapor pressure was 0.0650 MPa or more, and when the evaporation temperature was in a range of from −20 to 10° C., the saturated vapor pressure was 0.1013 MPa or more.

Meanwhile, in Examples 14 and 15, the content of HCFO-1224yd(Z) was more than 12.0% by mass, and when the evaporation temperature was −45° C., the saturated vapor pressure estimated as the evaporation pressure was less than 0.0300 MPa, when the evaporation temperature was −30° C., the saturated vapor pressure was less than 0.0650 MPa, and when the evaporation temperature was −20° C., the saturated vapor pressure was less than 0.1013 MPa.

Next, for the working medium of Example 7, based on the refrigeration cycle theoretical performance calculation, the refrigeration cycle state was calculated when the condensation temperature, the evaporation temperature, the superheating degree (SH), the subcooling degree (SC), and the compressor efficiency were set as the conditions in Table 4, and the discharge temperature was obtained.

For the working medium of Example 15, based on the refrigeration cycle theoretical performance calculation, the refrigeration cycle state was calculated when the condensation temperature, the evaporation temperature, the superheating degree (SH), the subcooling degree (SC), and the compressor efficiency were set as the conditions in Table 5, and the discharge temperature was obtained.

In addition, the difference (“Td difference” in Tables 4 and 5) between the discharge temperature of the working medium and the discharge temperature of R134a was calculated.

$$Td difference ( °C . ) = ( discharge temperature of working medium ( °C . ) ) - ( discharge temperature of HFC - 134 a ( °C . ) )$$

TABLE 4

| Condensation | Evaporation | | | Compressor | Discharge | Td |
|---|---|---|---|---|---|---|
| temperature | temperature | SH | SC | efficiency | temperature | difference |
| (° C.) | (° C.) | (° C.) | (° C.) | (—) | (° C.) | (° C.) |
| 40 | 10 | 5 | 0 | 0.7 | 51.59 | −3.81 |
| 40 | 5 | 5 | 0 | 0.7 | 52.66 | −4.84 |
| 40 | −5 | 5 | 0 | 0.7 | 55.19 | −7.11 |
| 40 | −10 | 5 | 0 | 0.7 | 56.70 | −8.30 |
| 40 | −20 | 5 | 0 | 0.7 | 60.28 | −10.82 |
| 40 | −30 | 5 | 0 | 0.7 | 64.79 | −13.51 |
| 40 | −45 | 5 | 0 | 0.7 | 73.79 | −17.91 |
| 40 | −50 | 5 | 0 | 0.7 | 77.53 | −19.47 |
| 30 | −45 | 0 | 0 | 0.7 | 58.19 | −15.61 |
| 30 | −45 | 0 | 0 | 1.0 | 36.39 | −10.98 |
| 30 | −45 | 20 | 0 | 0.7 | 79.98 | −16.77 |
| 30 | −45 | 20 | 0 | 1.0 | 56.12 | −11.86 |
| 30 | 10 | 0 | 0 | 0.7 | 35.70 | −1.80 |
| 30 | 10 | 5 | 0 | 0.7 | 40.67 | −1.88 |
| 30 | 10 | 20 | 0 | 0.7 | 55.70 | −2.09 |
| 30 | 10 | 0 | 0 | 1.0 | 32.07 | −0.13 |
| 30 | 10 | 20 | 0 | 1.0 | 50.60 | −1.13 |
| 35 | 10 | 0 | 0 | 0.7 | 41.22 | −2.68 |
| 35 | 10 | 5 | 0 | 0.7 | 46.17 | −2.87 |
| 35 | 10 | 10 | 0 | 0.7 | 51.15 | −2.98 |
| 35 | 10 | 20 | 0 | 0.7 | 61.17 | −3.13 |
| 35 | 10 | 0 | 0 | 1.0 | 36.98 | −0.62 |
| 35 | 10 | 10 | 0 | 1.0 | 45.36 | −1.90 |
| 35 | 10 | 20 | 0 | 1.0 | 55.04 | −1.96 |
| 40 | 10 | 5 | 0 | 0.7 | 51.59 | −3.81 |
| 50 | 10 | 5 | 0 | 0.7 | 62.21 | −5.59 |
| 60 | 10 | 5 | 0 | 0.7 | 72.67 | −7.17 |
| 65 | 10 | 5 | 0 | 0.7 | 77.88 | −7.88 |
| 70 | 10 | 5 | 0 | 0.7 | 83.09 | −8.51 |

TABLE 5

| Condensation | Evaporation | | | Compressor | Discharge | Td |
|---|---|---|---|---|---|---|
| temperature | temperature | SH | SC | efficiency | temperature | difference |
| (° C.) | (° C.) | (° C.) | (° C.) | (—) | (° C.) | (° C.) |
| 40 | 10 | 5 | 0 | 0.7 | 53.63 | −1.77 |
| 40 | 5 | 5 | 0 | 0.7 | 54.87 | −2.63 |
| 40 | −5 | 5 | 0 | 0.7 | 57.79 | −4.51 |
| 40 | −10 | 5 | 0 | 0.7 | 59.52 | −5.48 |
| 40 | −20 | 5 | 0 | 0.7 | 63.62 | −7.48 |
| 40 | −30 | 5 | 0 | 0.7 | 68.75 | −9.55 |
| 40 | −45 | 5 | 0 | 0.7 | 78.93 | −12.77 |
| 40 | −50 | 5 | 0 | 0.7 | 83.13 | −13.87 |
| 30 | −45 | 0 | 0 | 0.7 | 62.98 | −10.82 |
| 30 | −45 | 0 | 0 | 1.0 | 39.69 | −7.68 |
| 30 | −45 | 20 | 0 | 0.7 | 84.97 | −11.78 |
| 30 | −45 | 20 | 0 | 1.0 | 59.69 | −8.29 |
| 30 | 10 | 0 | 0 | 0.7 | 37.63 | 0.13 |
| 30 | 10 | 5 | 0 | 0.7 | 42.62 | 0.07 |
| 30 | 10 | 20 | 0 | 0.7 | 57.70 | −0.09 |
| 30 | 10 | 0 | 0 | 1.0 | 33.52 | 1.32 |
| 30 | 10 | 20 | 0 | 1.0 | 52.32 | 0.59 |
| 35 | 10 | 0 | 0 | 0.7 | 43.19 | −0.71 |
| 35 | 10 | 5 | 0 | 0.7 | 48.18 | −0.86 |
| 35 | 10 | 10 | 0 | 0.7 | 53.18 | −0.95 |
| 35 | 10 | 20 | 0 | 0.7 | 63.24 | −1.06 |
| 35 | 10 | 0 | 0 | 1.0 | 38.38 | 0.78 |
| 35 | 10 | 10 | 0 | 1.0 | 47.02 | −0.24 |
| 35 | 10 | 20 | 0 | 1.0 | 56.75 | −0.25 |
| 40 | 10 | 5 | 0 | 0.7 | 53.63 | −1.77 |
| 50 | 10 | 5 | 0 | 0.7 | 64.31 | −3.49 |
| 60 | 10 | 5 | 0 | 0.7 | 74.77 | −5.07 |
| 65 | 10 | 5 | 0 | 0.7 | 79.96 | −5.80 |
| 70 | 10 | 5 | 0 | 0.7 | 85.14 | −6.46 |

Comparison between Table 4 and Table 5 showed that the working medium of Example 7 had a discharge temperature reduction effect compared to the working medium of Example 15.

In particular, by applying the working medium of the disclosure under an operating condition in which the discharge temperature is high, in other words, under an operating condition in which the compression ratio is high (specifically, conditions in which the condensation temperature is high or the evaporation temperature is low) and under a condition in which the superheating degree is low, the discharge temperature reduction effect that can be obtained is great.

### <Stability Test>

Into a pressure-resistant vessel made of SUS316 with an internal volume of 200 mL (maximum operating temperature: 300° C. maximum operating pressure: 20 MPa), a Pyrex (registered trademark) inner tube with a pre-measured mass and one metal piece each made of SS400, Cu, and Al (20 mm×30 mm on each side, with a thickness of 2 mm), totaling three metal pieces, were inserted. After the pressure-resistant vessel was sealed, the vessel was evacuated to a vacuum. The inner tube was inserted in order to confirm the presence or absence of generation of a polymer in the pressure resistance test container.

Next, air and the working medium of Examples 1, 2, 6, 9, 12, 101, and 105 stored for 1 day in a thermostatic chamber set at 25° C. were filled in the pressure-resistant vessel. At this time, the air was filled in an amount in which the air concentration of the gas phase portion was as shown in Table 6 at 25° C.

As the HFO-1234yf, the HFO-1234ze(E), the HCFO-1224yd(Z), and the HFC-134a, those having a purity of 99.5% by mass or more were used.

In the air, the oxygen concentration was 21% by volume, the nitrogen concentration was 78% by volume, and the argon concentration was 1% by volume.

Next, the pressure-resistant vessel in which the working medium was sealed together with air having a predetermined concentration was installed in a hot air circulation type thermostatic bath, and left in a thermostatic state of 150° C. for 7 days.

After a lapse of 7 days, the pressure-resistant vessel was taken out from the thermostatic bath, and the appearance of metal pieces made of SS400, Cu, and Al was visually observed.

For the SS400 metal piece and the Al metal piece, no surface changes were observed even when the concentration of air was varied within the range of from 1.5 to 5.5% by volume. Meanwhile, a change in the surface of the Cu metal piece was confirmed when the concentration of air was changed within the range of from 1.5 to 5.5% by volume. Therefore, the appearance of the Cu metal piece after the test was compared with that of the Cu metal piece before the test, and the metal corrosion resistance was evaluated according to the following criteria. The results are shown in Table 6.
A: The surface of the metal piece was not discolored to brown.
B: A part of the surface of the metal piece was discolored to brown.
C: The entire surface of the metal piece was discolored to brown.

| | Working medium | | | | Determination of Cu metal piece | | | |
|---|---|---|---|---|---|---|---|---|
| | HFO- | | | HFC- | Air concentration | | | |
| | 1234yf | HFO- | HCFO- | 134a | 1.5 | 2.5 | 3.5 | 5.5 |
| | % by | 1234ze(E) | 1224yd(Z) | % by | % by | % by | % by | % by |
| | mass | % by mass | % by mass | mass | volume | volume | volume | volume |
| Example 1 | 73 | — | 12 | 15 | A | C | C | C |
| Example 2 | 82 | — | 3 | 15 | A | C | C | C |
| Example 6 | 87 | — | 3 | 10 | A | C | C | C |
| Example 9 | 85 | — | 12 | 3 | A | C | C | C |
| Example 12 | 92 | — | 4 | 4 | B | C | C | C |
| Example 101 | 38 | 35 | 12 | 15 | A | C | C | C |
| Example 105 | 68 | 5 | 12 | 15 | A | C | C | C |

As shown in Table 6, at an air concentration of from 2.5% by volume to 5.5% by volume (oxygen concentration of from 0.525% by volume to 1,155% by volume), all of the surfaces of the Cu metal pieces of Examples 1, 2, 6, 9, 12, 101, and 105 were discolored to brown. In the Cu metal piece of Example 12, a part of the surface was discolored to brown at an air concentration of 1.5% by volume. Meanwhile, in the Cu metal pieces of Examples 1, 2, 6, 9, 101, and 105 in which the content of HFO-1234yf was 90.0% by mass or less, the surface was not discolored to brown at an air concentration of 1.5% by volume.

Further, from Examples 1, 101, and 105, it was found that even when a part of the HFO-1234yf is replaced with the HFO-1234ze(E), similar results are obtained.

The disclosure of Japanese Patent Application No. 2023-091156 filed on Jun. 1, 2023 is incorporated herein by reference in its entirety. In addition, all documents, patent applications, and technical standards described in this specification are incorporated herein by reference to the same extent as if each document, patent application, and technical standard were specifically and individually described to be incorporated by reference.

1. A working medium containing 2,3,3,3-tetrafluoropropene, (Z)-1-chloro-2,3,3,3-tetrafluoropropene, and 1,1,1,2-tetrafluoroethane, wherein:
a content of the 1,1,1,2-tetrafluoroethane is 15.0% by mass or less relative to a total content of the 2,3,3,3-tetrafluoropropene, the (Z)-1-chloro-2,3,3,3-tetrafluoropropene, and the 1, 1,1,2-tetrafluoroethane,
a content of the (Z)-1-chloro-2,3,3,3-tetrafluoropropene is 12.0% by mass or less relative to the total content of the 2,3,3,3-tetrafluoropropene, the (Z)-1-chloro-2,3,3,3-tetrafluoropropene, and the 1,1,1,2-tetrafluoroethane, and
a content of the 2,3,3,3-tetrafluoropropene is 73.0% by mass or more relative to the total content of the 2,3,3,3-tetrafluoropropene, the (Z)-1-chloro-2,3,3,3-tetrafluoropropene, and the 1,1,1,2-tetrafluoroethane.

2. The working medium according to claim 1, wherein the total content of the 2,3,3,3-tetrafluoropropene, the (Z)-1-chloro-2,3,3,3-tetrafluoropropene, and the 1,1,1,2-tetrafluoroethane is 65.0% by mass or more relative to a total amount of the working medium.

3. The working medium according to claim 2, further containing (E)-1,3,3,3-tetrafluoropropene.

4. The working medium according to claim 1, wherein the total content of the 2,3,3,3-tetrafluoropropene, the (Z)-1-chloro-2,3,3,3-tetrafluoropropene, and the 1,1,1,2-tetrafluoroethane is 99.0% by mass or more relative to a total amount of the working medium.

5. The working medium according to claim 1, wherein the content of the 2,3,3,3-tetrafluoropropene is in a range of from 80.0 to 90.0% by mass relative to the total content of the 2,3,3,3-tetrafluoropropene, the (Z)-1-chloro-2,3,3,3-tetrafluoropropene, and the 1,1,1,2-tetrafluoroethane.

6. The working medium according to claim 1, wherein an oxygen concentration in a gas phase portion of the working medium at 25° C., is 0.315% by volume or less.

7. The working medium according to claim 6, wherein the content of the 2,3,3,3-tetrafluoropropene is 90.0% by mass or less relative to the total content of the 2,3,3,3-tetrafluoropropene, the (Z)-1-chloro-2,3,3,3-tetrafluoropropene, and the 1,1,1,2-tetrafluoroethane.

8. A composition for a thermal cycle system, comprising: the working medium according to claim 1; and a refrigerating machine oil.

9. The composition for a thermal cycle system according to claim 8, wherein the refrigerating machine oil is at least one selected from the group consisting of polyalkylene glycol oil, polyol ester oil, polyvinyl ether oil, and mineral oil.

10. The composition for a thermal cycle system according to claim 8, wherein a kinematic viscosity of the refrigerating machine oil at 40° C., is 700 mm²/s or less.

11. A thermal cycle device comprising:
the working medium according to claim 1;
a compressor that compresses vapor of the working medium;
a condenser that cools and liquefies the vapor of the working medium discharged from the compressor;
a pressure-reducing device that reduces a pressure of the working medium discharged from the condenser; and
an evaporator that heats the working medium discharged from the pressure-reducing device.

12. The thermal cycle device according to claim 11, wherein an evaporation temperature of the working medium in the evaporator is controlled to be in a range of from −45 to 10° C.

13. The thermal cycle device according to claim 11, wherein an evaporation temperature of the working medium in the evaporator is controlled to be in a range of from −30 to 10° C.

14. The thermal cycle device according to claim 11, wherein an evaporation temperature of the working medium in the evaporator is controlled to be in a range of from −20 to 10° C.

15. The thermal cycle device according to claim 11, wherein at least a part of each surface that comes into contact with the working medium, in components constituting the thermal cycle device, includes at least one selected from the group consisting of copper and copper alloys.

16. A thermal cycle device comprising:
the working medium according to claim 7;
a compressor that compresses vapor of the working medium;
a condenser that cools and liquefies the vapor of the working medium discharged from the compressor;
a pressure-reducing device that reduces a pressure of the working medium discharged from the condenser; and
an evaporator that heats the working medium discharged from the pressure-reducing device,
wherein at least a part of each surface that comes into contact with the working medium, in components constituting the thermal cycle device, includes at least one selected from the group consisting of copper and copper alloys.

17. The thermal cycle device according to claim 15, wherein each of the components is at least one selected from the group consisting of the compressor, the condenser, the evaporator, and a refrigerant pipe.

18. A thermal cycle method comprising:
compressing vapor of the working medium according to claim 1;
cooling and liquefying the vapor of the working medium;
reducing a pressure of the liquefied working medium; and
heating the pressure-reduced working medium.

19. A working medium containing 2,3,3,3-tetrafluoropropene, (E)-1,3,3,3-tetrafluoropropene, (Z)-1-chloro-2,3,3,3-tetrafluoropropene, and 1,1,1,2-tetrafluoroethane, wherein:
a content of the 1,1,1,2-tetrafluoroethane is 15.0% by mass or less relative to a total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane;
a content of the (E)-1,3,3,3-tetrafluoropropene is 35.0% by mass or less relative to the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane;
a content of the (Z)-1-chloro-2,3,3,3-tetrafluoropropene is 12.0% by mass or less relative to the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane; and
a content of the 2,3,3,3-tetrafluoropropene is 38.0% by mass or more relative to the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane.

20. The working medium according to claim 19, wherein the total content of the 2,3,3,3-tetrafluoropropene, the (E)-1,3,3,3-tetrafluoropropene, the (Z)-1-chloro-2,3,3,3-tetrafluoropropene, and the 1,1,1,2-tetrafluoroethane is 99.0% by mass or more relative to a total amount of the working medium.

21. The working medium according to claim 19, wherein an oxygen concentration in a gas phase portion of the working medium at 25° C., is 0.315% by volume or less.
